(19) United States
(12) Patent Application Publication
(10) Pub. No.: US 2015/0085781 A1
(43) Pub. Date: Mar. 26, 2015

(54) Communication Apparatus, Communication Method, Communication System, Control Apparatus and Program

(71) Applicant: NEC CORPORATION, Minato-ku, Tokyo (JP)

(72) Inventors: Nobuhiko Itoh, Tokyo (JP); Ippei Akiyoshi, Tokyo (JP); Yasuhiro Mizukoshi, Tokyo (JP)

(21) Appl. No.: 14/395,801

(22) PCT Filed: Apr. 26, 2013
(86) PCT No.: PCT/JP2013/002839

§ 371 Date: Oct. 20, 2014

(30) Foreign Application Priority Data
Apr. 27, 2012 (JP) 2012-102577

(51) Int. Cl. H04L 29/12; H04W 8/26

(52) U.S. Cl. CPC H04L 61/2539; H04W 8/26
USPC 370/329

(57) ABSTRACT

A communication apparatus includes: a communication unit that communicates with a network by at least one of a plurality of communication schemes; and a control unit that disguises a first communication address corresponding to a first communication scheme, by a second communication address corresponding to a second communication scheme, based on an instruction transmitted from a control apparatus.

### CROSS-REFERENCE TO RELATED APPLICATIONS

The present invention is based upon and claims the benefit of the priority of Japanese Patent Application No. 2012-102577, filed on Apr. 27, 2012, the disclosure of which is incorporated herein in its entirety by reference thereto.

### FIELD

The present invention relates to a communication apparatus, a communication method, a communication system, a control apparatus and a program, and in particular to a communication apparatus, a communication method, a communication system, a control apparatus and a program, which perform communication by at least one of a plurality of communication schemes.

### BACKGROUND

In recent years, it has become possible for mobile terminals to connect to a plurality of types of RAT (Radio Access Technology). For example, a mobile terminal can connect to a plurality of RATs such as 3GPP (Third Generation Partnership Project) access including UTRAN (UMTS Terrestrial Radio Access Network) and LTE (Long Term Evolution), and WLAN (Wireless Local Area Network) including 802.11g and 802.11n, or the like.

Patent Literature PTL 1 (Japanese Translation of PCT International Publication, Publication No. 2011-524686) discloses an apparatus that decides which access network to use, among a plurality of access networks (namely, a plurality of RATs).

Patent Literature PTL 2 (Japanese Patent Kokai Publication No. 2011-217174) discloses technology for connecting to a dedicated network from a terminal connected to the Internet.

### CITATION LIST

### Patent Literature

### [PTL 1]

Japanese Patent Kohyo Publication No. JP2011-524686A

### [PTL 2]

Japanese Patent Kokai Publication No. JP2011-217174A

### SUMMARY

### Technical Problem

The entire disclosures of the above Patent Literatures PTL 1 and PTL 2 are incorporated herein by reference thereto. The following analyses are given by the present invention. The above Patent Literature PTL 1 and PTL 2 do not disclose how a communication terminal handles a case where a plurality of communication addresses from a plurality of RATs are assigned to the communication terminal.

In a case of communicating with a plurality of RATs, it is assumed that with regard to a communication apparatus (such as a communication terminal), a plurality of communication addresses are assigned from the plurality of RATs. In the case where a plurality of communication addresses are assigned, if the communication apparatus does not handle the determination of an address to be used, among the plurality of communication addresses, there is a possibility of a failure occurring in communication.

### Solution to Problem

According to a first aspect of the present invention, there is provided a communication apparatus, comprising: communication means (unit) that communicates with a network by at least one of a plurality of communication schemes; and control means (unit) that disguises a first communication address corresponding to a first communication scheme, by a second communication address corresponding to a second communication scheme, based on an instruction transmitted from a control apparatus.

According to a second aspect of the present invention, there is provided a communication method, the method comprising:

using a communication apparatus that communicates with a network by at least one of a plurality of communication schemes;
disguising a first communication address corresponding to a first communication scheme, by a second communication address corresponding to a second communication scheme, based on an instruction transmitted from a control apparatus; and
communicating using the disguised communication address.

According to a third aspect of the present invention, there is provided a communication system, the system comprising:

at least one communication apparatus; and
a control apparatus that controls packet processing by the communication apparatus; wherein
the communication apparatus comprises:
communication means (unit) that communicates with a network by at least one of a plurality of communication schemes; and
control means (unit) that disguises a first communication address corresponding to a first communication scheme, by a second communication address corresponding to a second communication scheme, based on an instruction transmitted from the control apparatus.

According to a fourth aspect of the present invention, there is provided a control apparatus, the control apparatus comprising:

means (unit) that communicates with a communication apparatus that uses at least one of a plurality of communication schemes; and
means (unit) that transmits to the communication apparatus an instruction to disguise a first communication address corresponding to a first communication scheme, by a second communication address corresponding to a second communication scheme.

According to a fifth aspect of the present invention, there is provided a communication method, the method comprising:

communicating with a communication apparatus that uses at least one of a plurality of communication schemes; and
transmitting to the communication apparatus an instruction to disguise a first communication address corresponding to a first communication scheme, by a second communication address corresponding to a second communication scheme.

According to a sixth aspect of the present invention, there is provided a program, the program causing a communication apparatus that communicates with a network by at least one of a plurality of communication schemes to execute:

disguising a first communication address corresponding to a first communication scheme, by a second communication address corresponding to a second communication scheme, based on an instruction transmitted from a control apparatus.

There is also provided a non-transitory computer-readable recording medium storing the program.

### Advantageous Effects of Invention

A communication apparatus of the present invention, with regard to a plurality of communication addresses being assigned from a plurality of RATs, can perform communication with a network without being aware of which address should be used.

### BRIEF DESCRIPTION OF DRAWINGS

FIG. 1 is a diagram showing a system configuration example of a first exemplary embodiment.

FIG. 2 is a sequence diagram showing an operation example of the first exemplary embodiment.

FIG. 3 is a diagram showing a configuration example of a communication apparatus of the first exemplary embodiment.

FIG. 4 is a diagram showing an example of functionality of a control unit.

FIG. 5 is a diagram showing an example of functionality of the control unit.

FIG. 6 is a sequence diagram showing an operation example of the first exemplary embodiment.

FIG. 7 is a diagram showing a configuration example of a control apparatus.

FIG. 8 is a diagram showing an example of information communicated by the communication apparatus to the control apparatus.

FIG. 9 is an example of a database held by a management DB of the control apparatus.

FIG. 10 is a diagram showing a configuration example of a communication apparatus of a third exemplary embodiment.

FIG. 11 is a diagram showing a configuration example of a control apparatus of the third exemplary embodiment.

FIG. 12 is an example of a database held by a policy DB of the control apparatus.

FIG. 13 is an example of a database held by the policy DB of the control apparatus.

FIG. 14 is an example of a database held by the policy DB of the control apparatus.

FIG. 15 is an example of a database held by the policy DB of the control apparatus.

FIG. 16 is a diagram showing a system configuration example of a fourth exemplary embodiment.

FIG. 17 is a diagram describing technology related to the fourth exemplary embodiment.

FIG. 18 is a diagram describing technology related to the fourth exemplary embodiment.

FIG. 19 is a diagram showing a configuration example of the communication apparatus of the fourth exemplary embodiment.

FIG. 20 is a diagram showing a configuration example of a packet forwarding function unit.

FIG. 21 is a diagram showing an example of information notified by the communication apparatus to the control apparatus.

FIG. 22 is a diagram showing a configuration example of the control apparatus of the fourth exemplary embodiment.

FIG. 23 is a diagram showing an example of a database held by the control apparatus.

FIG. 24 is a diagram showing an example of a packet processing rule generated by the control apparatus.

FIG. 25 is a sequence diagram showing an operation example of the fourth exemplary embodiment.

FIG. 26 is a diagram showing a system configuration example of a fifth exemplary embodiment.

FIG. 27 is a diagram showing an example of information managed by the control apparatus.

FIG. 28 is a diagram showing an example of an instruction notified by the control apparatus to the communication apparatus.

FIG. 29 is a diagram showing an example of an instruction notified by the control apparatus to a packet forwarding apparatus.

### DESCRIPTION OF EMBODIMENTS

### First Exemplary Embodiment

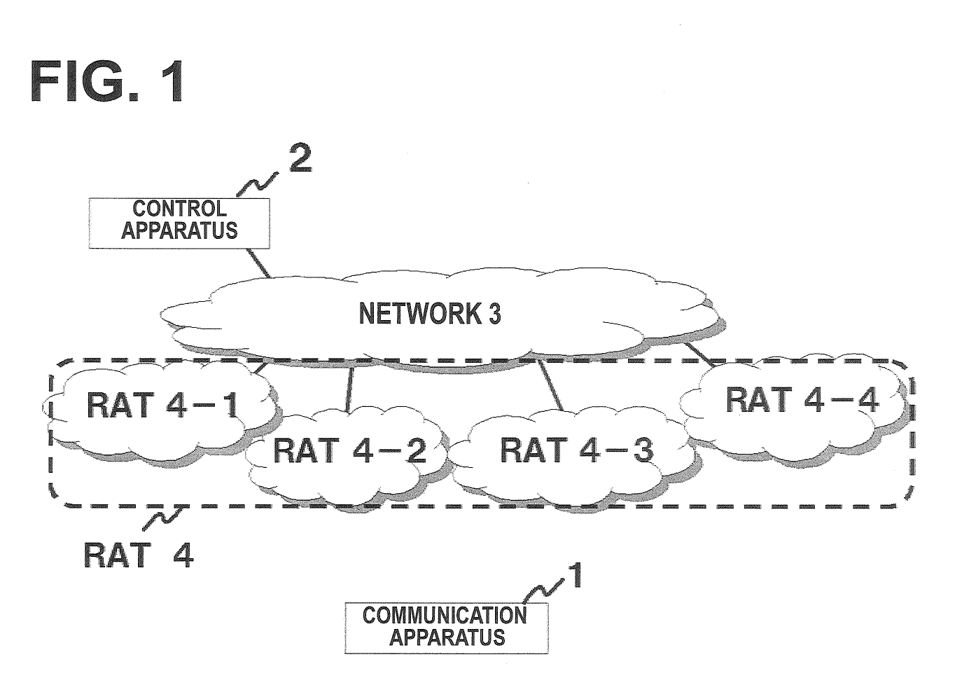

FIG. 1 shows a configuration example of a system in a first exemplary embodiment. The system includes a communication apparatus 1, a control apparatus 2, a network 3, and RATs 4. It is to be noted that reference symbols in the drawing are added as examples in order to aid understanding, and are not intended to limit the present invention to modes shown in the drawings. Similarly, reference symbols in drawings related to other exemplary embodiments are also not intended to limit the present invention to modes shown in the drawings.

The communication apparatus 1 can communicate with a plurality of RATs (communication schemes). The communication apparatus 1 is connected with any of the RATs (RAT 4-1, RAT 4-2, RAT 4-3, RAT 4-4) shown as examples in FIG. 1, to communicate with the network 3. It is to be noted that the communication apparatus 1 (for example, wireless communication terminal) may be connected to a plurality of RATs (for example, RAT 4-1 and RAT 4-2), among the RATs shown as examples in FIG. 1, to communicate with the network 3.

The communication apparatus 1 is an apparatus having a communication function such as, for example, a mobile telephone, a personal computer, a network switch, a router, a mobile router, or the like. It is to be noted that the mobile router, for example, is a terminal to relay a mobile telephone 3G line or a wireless LAN network.

RAT 4 is an access network for the communication apparatus 1 to connect with the network 3. It is to be noted that RAT 4 includes access networks such as, for example, a UTRAN network, an LTE network, a WLAN network, WiMAX (Worldwide Interoperability for Microwave Access), and the like.

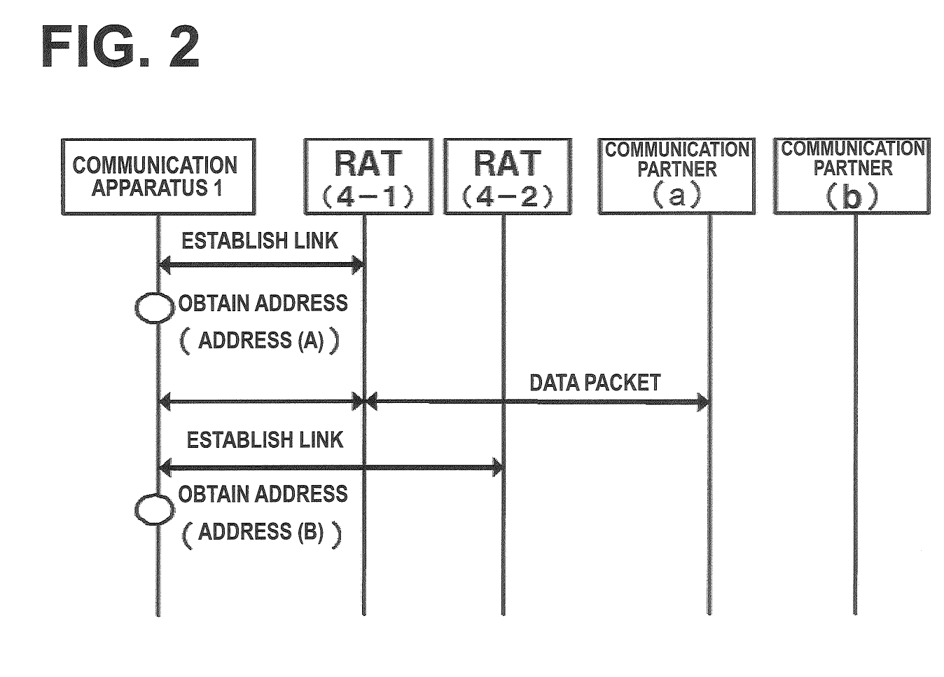

FIG. 2 shows an operation example in which the communication apparatus 1 establishes a link with a plurality of RATs, and obtains a plurality of communication addresses.

The communication apparatus 1 establishes a link with RAT 4-1, and obtains a communication address (address (A)) corresponding to RAT 4-1, from RAT 4-1. The communication apparatus 1 executes communication by data packets with a communication partner (a), using the obtained communication address.

In a case where a link is established with RAT 4-2 while maintaining a link with RAT 4-1, the communication apparatus 1 obtains a communication address (address (B)) from RAT 4-2. As a result, the communication apparatus 1 obtains a plurality of communication addresses (address (A) and address (B)) from a plurality of RATs.

In a case of obtaining a plurality of communication addresses, for example, there is a possibility of it not being clear which of the plurality of communication addresses an application operating in the communication apparatus 1 should use.

The communication apparatus 1 is provided with a function to enable communication without determining which of the plurality of communication addresses should be used.

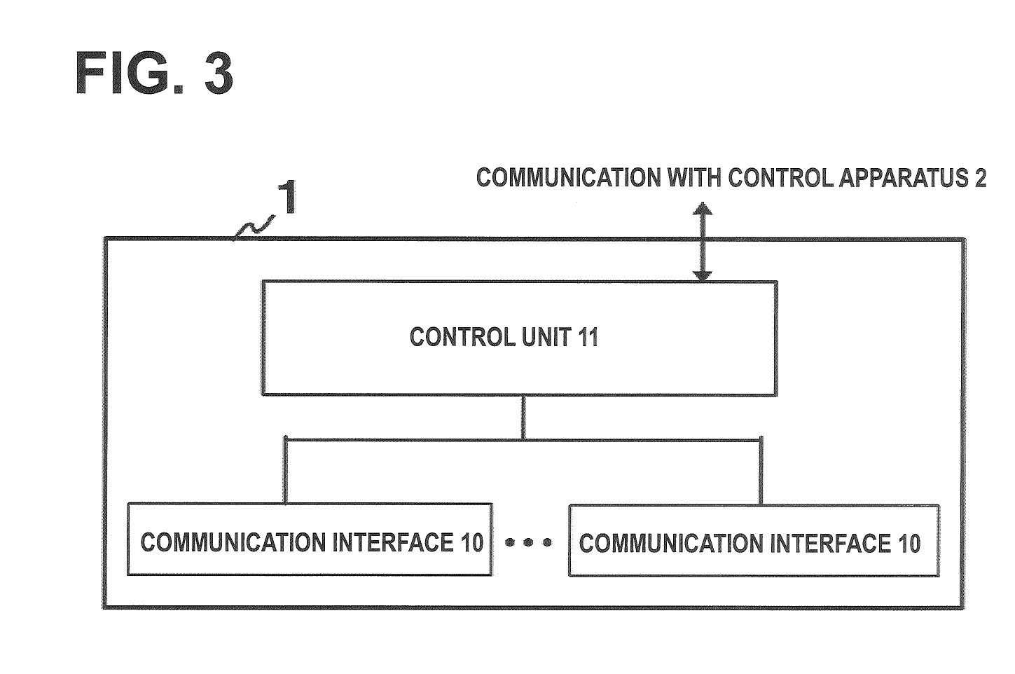

FIG. 3 shows a configuration example of the communication apparatus 1.

The communication apparatus 1 includes a control unit 11 and communication interfaces 10.

A communication interface 10, for example, is an antenna or the like. The respective communication interfaces 10 correspond to at least one of the plurality of RATs. For example, a communication interface 10 corresponds to a certain RAT (for example, an UTRAN), and the communication apparatus 1 connects with a certain RAT (for example, an UTRAN) via the communication interface 10 in question.

Furthermore, for example, a communication interface 10 corresponds to a plurality of RATs (for example, RATs 4-2 and 4-3), and the communication apparatus 1 connects with any of the corresponding plurality of RATs via the communication interface 10 in question. In this case, the communication apparatus 1 may have a configuration having a single communication interface 10.

The control unit 11 disguises a communication address corresponding to a certain communication scheme, based on an instruction from the control apparatus 2, by a communication address corresponding to another communication scheme. The control unit 11 communicates with the control apparatus 2 and receives an instruction related to the disguise of the communication address.

The control unit 11 communicates with the control apparatus 2 via a communication interface. The control unit 11, for example, refers to a network address of the control apparatus 2 that is set in advance in the communication apparatus 1, and communicates with the control apparatus 2. When the communication apparatus 1 connects with a RAT with which it is attempting to establish a link at startup or the like, being a communication line of a network operator to which the communication apparatus 1 is subscribed, the control unit 11 may obtain an address of the control apparatus 2 from the network side. For example, when a request to generate a logical channel (for example, a bearer) is made to a wireless station of a RAT for which a link is established, the control unit 11 also requests an address (IP (Internet Protocol) address or the like) of the control apparatus 2. The control unit 11 may access the control apparatus 2 using a prescribed URL (Uniform Resource Locator), and may establish a VPN (Virtual Private Network) with the control apparatus 2. It is to be noted that a method by which the control unit 11 communicates with the control apparatus 2 is not limited to the method described above.

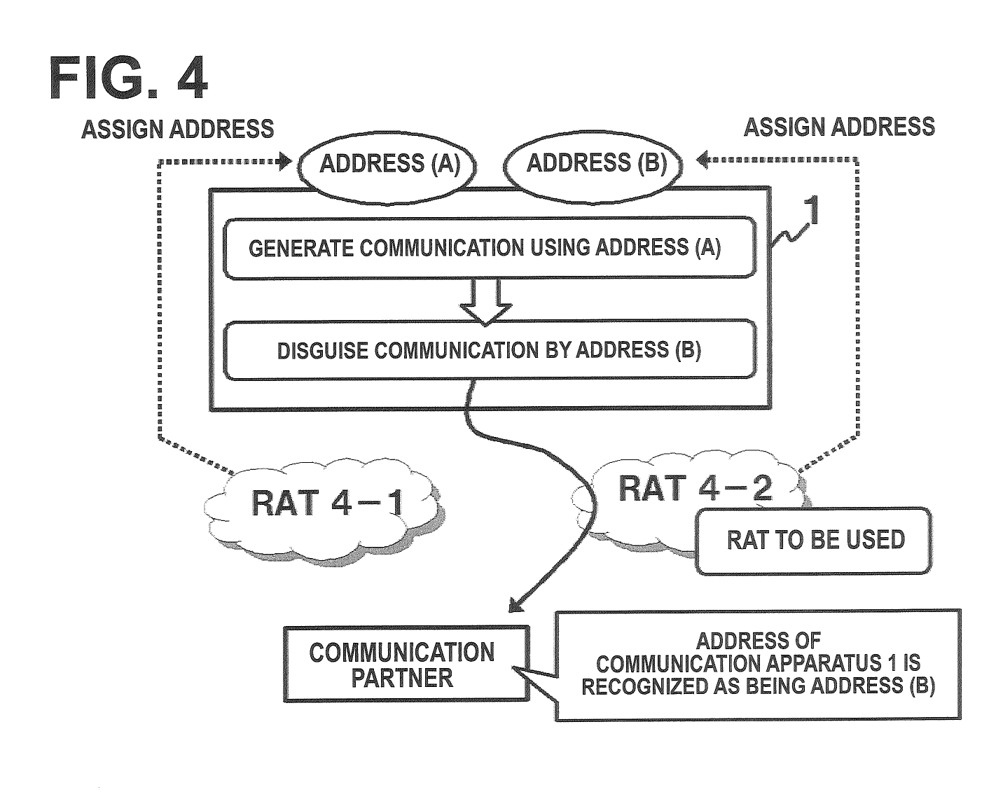

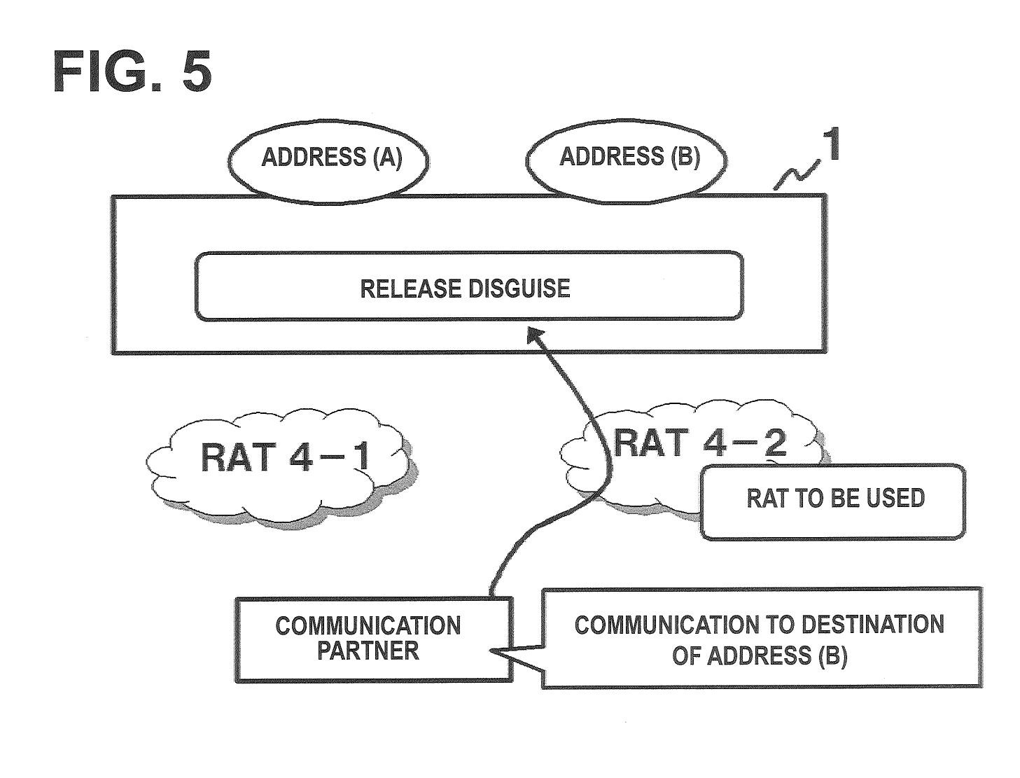

FIG. 4 and FIG. 5 show an outline of functions provided by the control unit 11. It is to be noted that FIG. 4 and FIG. 5 are examples, and the functions of the control unit 11 are not limited to FIG. 4 and FIG. 5.

The communication apparatus 1 obtains a communication address (A) from the RAT 4-1, and obtains a communication address (B) from RAT 4-2.

An application running on the communication apparatus 1 uses the communication address (A) to attempt communication with a communication partner in the network. The control unit 11 is instructed by the control apparatus 2 to communicate via the RAT 4-2.

The control unit 11 disguises a communication address (A) by a communication address (B) corresponding to a RAT used in communication, based on an instruction from the control apparatus 2. Since the control unit 11 disguises the address, the communication partner recognizes the address of the communication apparatus 1 as if it were the communication address (B).

Since the control unit 11 disguises an address based on an instruction of the control apparatus 2, an application running on the communication apparatus 1 can commence communication by an arbitrary communication address, among a plurality of communication addresses set in the communication apparatus 1. That is, the application need not determine a communication address used in communication. Accordingly, a maker of an application operated by the communication apparatus 1 need not add to the application a function for handling a case where a plurality of communication addresses are assigned to the communication apparatus 1.

In a case where a communication address used by an application does not corresponding to a RAT used by the communication apparatus 1 in communication, if there is no function corresponding to the control unit 11, there is a possibility of a failure occurring in communication. However, by the communication address being disguised by the control unit 11, even in a case where a communication address used by an application does not correspond to a RAT used by the communication apparatus 1 in communication, the communication apparatus 1 is able to perform communication.

Since the address of the communication apparatus 1 is recognized as a communication address (B), as shown in FIG. 5, a communication partner transmits a response to the communication apparatus 1, to a destination of the communication address (B).

The control unit 11 releases the disguise of the communication with the communication address (B). That is, the control unit 11 delivers the communication with the destination of the communication address (B) delivered from the communication partner to the application, as a communication with a destination of the communication address (A).

It is to be noted that the control unit 11 can also be configured by a software application. For example, the communication apparatus may download a software application having a function corresponding to the control unit 11, from a server on the network. The server that delivers the software application to the communication apparatus 1, for example, is provided with a function to communicate with the communication apparatus 1 via the network 3 of the communication system shown in FIG. 1, and to deliver a software application corresponding to the control unit 11, to the communication apparatus 1.

The control unit 11 may have a function to enable communication with the control apparatus 2, without disguising the communication address. For example, the control unit 11 is provided with a function to select a communication address corresponding to a RAT used in communication with the control apparatus 2. The RAT used in communication with the control apparatus 2 may be set in advance in the control unit 11.

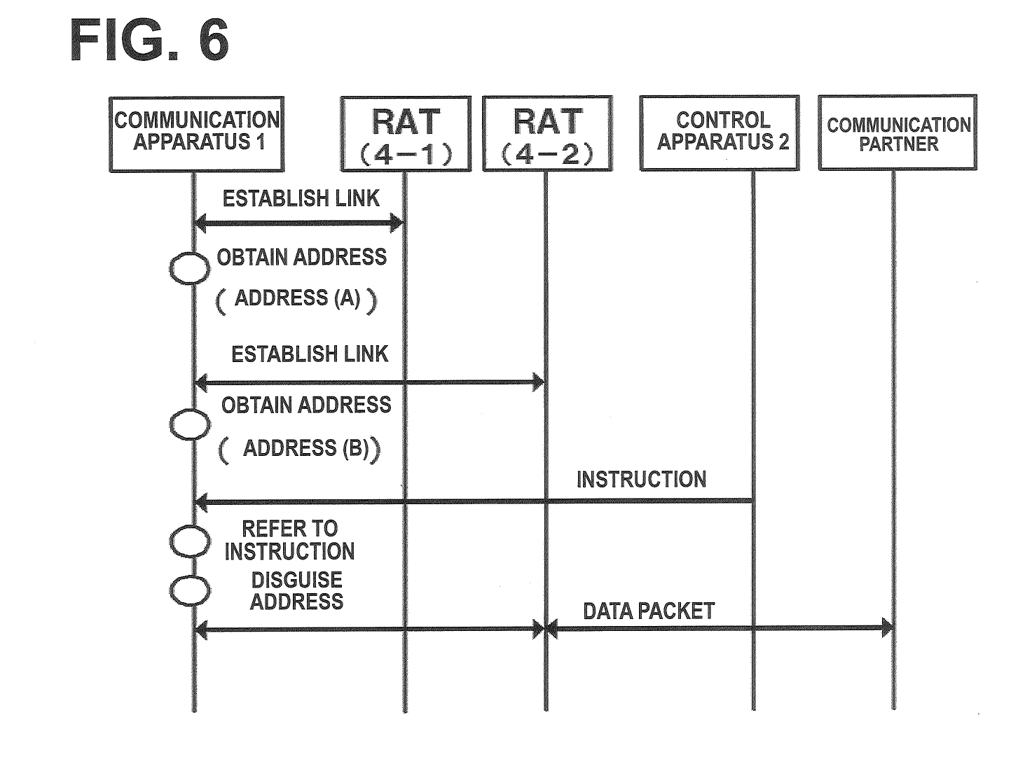

FIG. 6 shows an operation example in the first exemplary embodiment.

The communication apparatus 1 obtains a plurality of communication addresses from a plurality of RATs, in a sequence the same as the operation example shown in FIG. 2.

The control apparatus 2 determines a RAT to be used by the communication apparatus 1. The control apparatus 2 transmits an instruction indicating that a communication address is to be disguised, based on the determined RAT, to the communication apparatus 1. For example, the control apparatus 2 instructs the communication apparatus 1 to disguise the communication address to be used by an application, with a communication address corresponding to the determined RAT.

It is to be noted that timing at which the control apparatus 2 transmits an instruction to the communication apparatus 1 may be arbitrary. For example, the instruction may be transmitted in advance, before the communication apparatus 1 commences communication. For example, a request may be made for the instruction to the control apparatus 2 when the communication apparatus 1 commences communication, and the control apparatus 2 may transmit the instruction in response to the request.

The control unit 11 disguises a communication address, making reference to the instruction of the control apparatus 2, and communicates with a communication partner.

### Second Exemplary Embodiment

A system configuration example of a second exemplary embodiment is similar to FIG. 1. A configuration example of a communication apparatus 1 in the second exemplary embodiment is similar to FIG. 3.

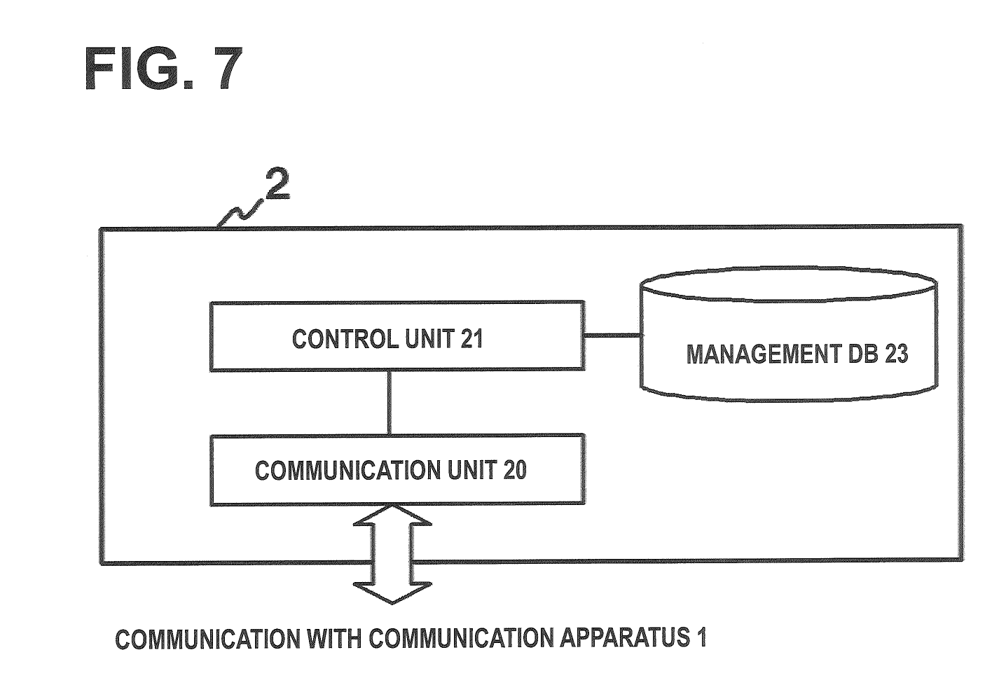

FIG. 7 shows a configuration example of a control apparatus 2.

The control apparatus 2 includes a communication unit 20, a control unit 21, and a management DB (Database) 23.

The communication unit 20 has a function for communicating with the communication apparatus 1. The control apparatus 2 transmits an instruction related to disguising a communication address to the communication apparatus 1, via the communication unit 20.

The control unit 21 makes reference to the management DB 23 and generates an instruction related to disguising a communication address. The control unit 21 builds a database of the management DB 23, based on information notified from the communication apparatus 1.

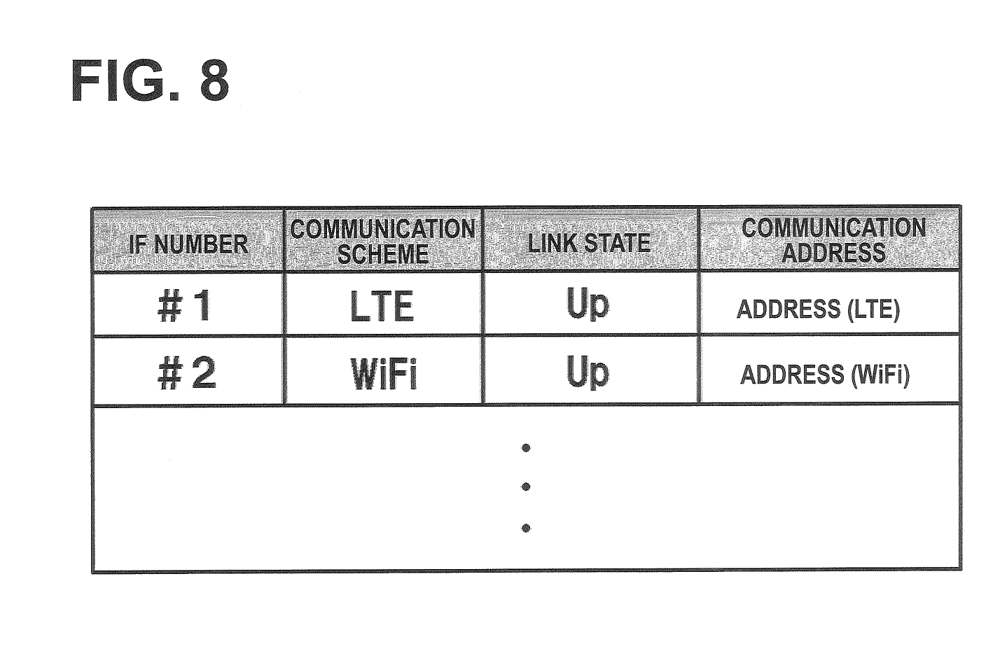

FIG. 8 shows an example of information notified by the communication apparatus 1 to the control apparatus 2. The communication apparatus 1, for example, notifies a communication scheme corresponding to an interface, an interface state (for example, whether or not a link is established with a communication network), and a communication address corresponding to the interface, to the control apparatus 2. By the information being notified by the communication apparatus 1, the control apparatus 2 recognizes a state of the communication apparatus 1 (for example, assigned communication address).

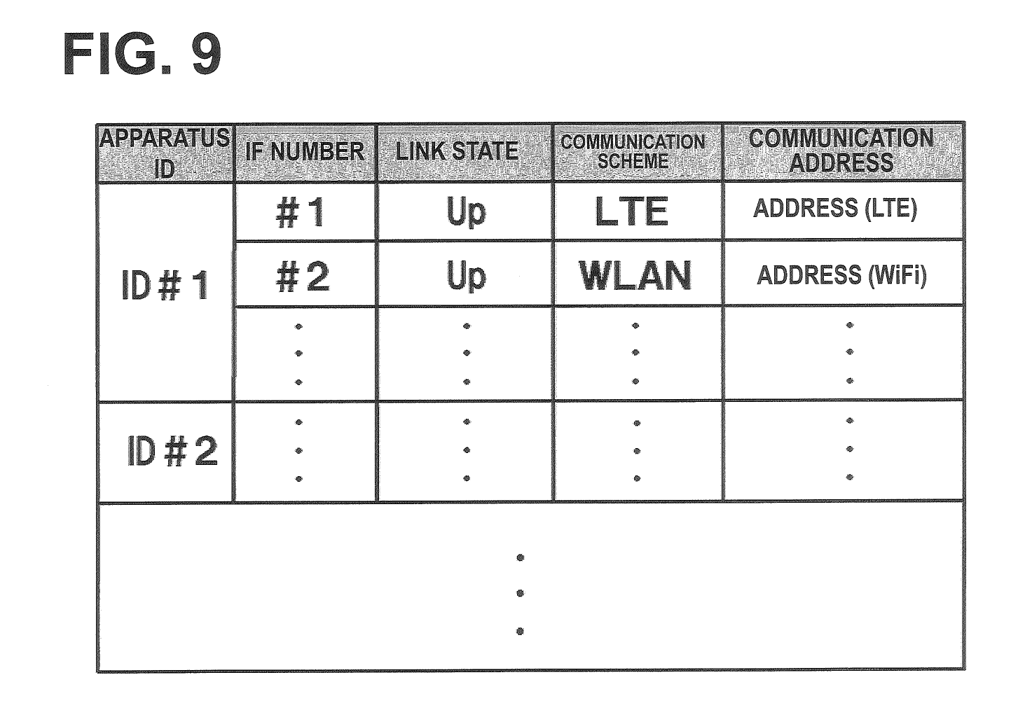

FIG. 9 shows an example of a database built by the control unit 21 in the management DB 23.

The management DB 23 manages information notified by respective communication apparatuss 1, for each communication apparatus 1. The management DB 23 distinguishes a communication apparatus according to an ID of the communication apparatus 1. The ID of the communication apparatus 1, for example, is an IMSI (International Mobile Subscriber Identity) or the like.

The control unit 21 makes reference to the management DB 23 and generates an instruction related to a RAT (communication scheme) used by the communication apparatus 1, and to disguising a communication address. The control unit 21, for example, determines the RAT to be used by the communication apparatus 1, from a RAT for which a link is established. The control unit 21, for example, uses a communication address corresponding to the determined RAT to generate an instruction to disguise a communication address generated by the communication apparatus 1.

### Third Exemplary Embodiment

In a third exemplary embodiment, a control unit 11 of a communication apparatus carries out disguising with a communication address, by an instruction determined by the abovementioned control apparatus based on a status of the communication apparatus, which changes with movement of the communication apparatus.

A system configuration of the third exemplary embodiment is similar to FIG. 1. However, configurations of the communication apparatus and the control apparatus are different from the exemplary embodiments described above. In the third exemplary embodiment, the communication apparatus and the control apparatus are respectively described as the communication apparatus 1A and the control apparatus 2A.

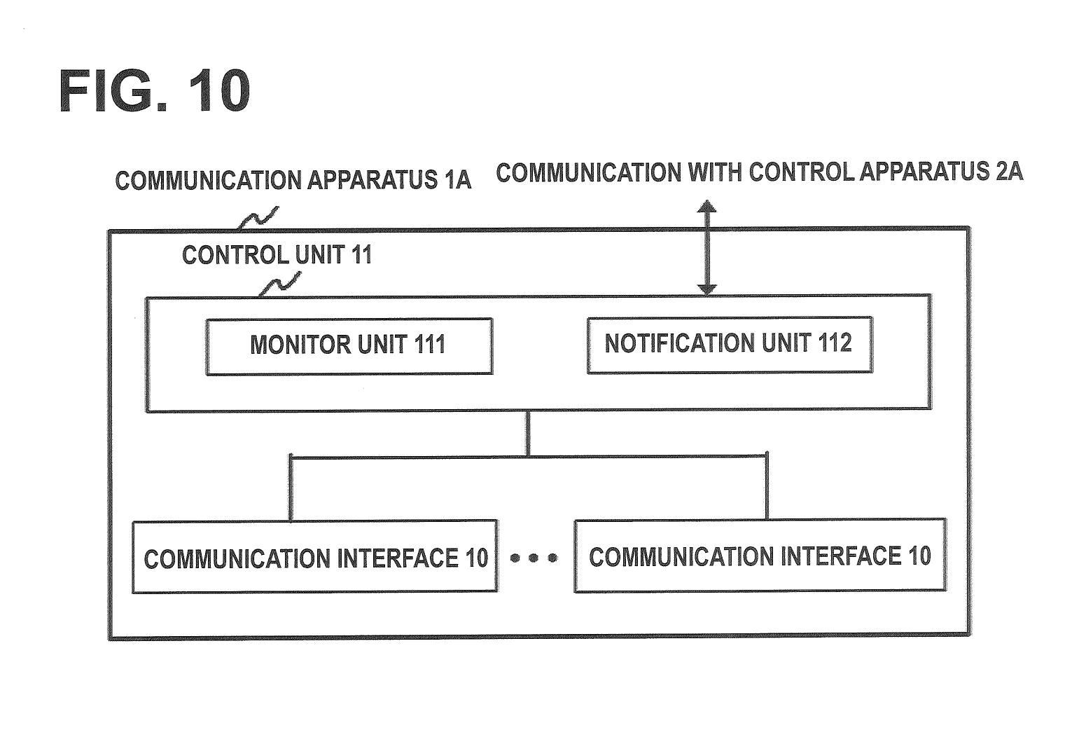

FIG. 10 shows a configuration example of the communication apparatus 1A in the third exemplary embodiment. The control unit 11 of the communication apparatus 1A includes a monitor unit 111 and a notification unit 112. The configuration is otherwise the same as the configuration example of FIG. 2.

The monitor unit 111 monitors status that changes in accordance with movement of the communication apparatus 1A. The status which changes in accordance with movement is, for example, the location of the communication apparatus 1A, a RAT that can be used by the communication apparatus 1A, the radio wave reception intensity of each communication interface, or the like.

The monitor unit 111, for example, searches for a RAT 4 that can be used in the vicinity of the communication apparatus 1A, via the respective communication interfaces 10. The monitor unit 111, for example, searches for a useable RAT 4, via all of the communication interfaces 10. The monitor unit 111 may search for a useable RAT 4 via an interface that is running, among a plurality of communication interfaces. The monitor unit 111, for example, searches for a useable RAT 4 based on radio wave conditions corresponding to respective RATs 4.

The monitor unit 111 may measure information related to the location of the communication apparatus 1A, or information related to radio wave conditions such as the radio wave reception intensity or the like, via a communication interface 10. The information related to the location of the communication apparatus 1A is, for example, GPS (Global Positioning System) information, cell ID (ID of a cell corresponding to a cover area of a wireless base station), or the like.

The notification unit 112 gives notification of information (referred to below as status information) related to status of the communication apparatus 1A, monitored by the monitor unit 111, to the control apparatus 2A. The notification unit 112 gives notification of the status information to the control apparatus 2A by a communication interface 10 corresponding to a RAT for which the communication apparatus 1A establishes a link. The notification unit 112 may give notification of an identifier of the communication apparatus 1A together with the status information, to the control apparatus 2A.

It is to be noted that the notification unit 112 may have a function to enable communication with the control apparatus 2A, without disguising a communication address. For example, the notification unit 112 is provided with a function to select a communication address corresponding to a RAT used in communication with the control apparatus 2A. The RAT used in communication with the control apparatus 2A may be set in advance in the notification unit 112.

The notification unit 112, for example, notifies the control apparatus 2A of an identifier of a detected RAT or information related to radio wave conditions such as the reception field intensity, as status information. The RAT identifier is, for example, a SSID (Service Set Identifier) or a PLMN (Public Land Mobile Network) identifier. The notification unit 112 may give notification of information related to the location of the communication apparatus 1A to the control apparatus 2A as status information. The information related to the location of the communication apparatus 1A is, for example, GPS information, cell ID (ID of a cell corresponding to a cover area of a wireless base station), or the like.

The control apparatus 2A determines a RAT to be used by the communication apparatus 1A, based on the status information notified by the communication apparatus 1A. The control apparatus 2A transmits an instruction to disguise a communication address, to the communication apparatus 1A, according to a communication address corresponding to the determined RAT.

The control apparatus 2A may determine a RAT to which the communication apparatus 1A is connected, and may identify a connection apparatus (for example, a WiFi access point) in order to connect with the RAT. The control apparatus 2A may instruct a communication apparatus 1A to connect with a specified connection apparatus. The control apparatus 2A, for example, gives notification of an SSID of a WiFi access point to the communication apparatus 1A, and instructs that a connection be made to the access point of the SSID in question.

The monitor unit 111 monitors the state of the communication apparatus 1A at prescribed timing. For example, the monitor unit 111 monitors the state of the communication apparatus 1A at a prescribed period. The monitor unit 111 may monitor the state of the communication apparatus 1A when instructed to do so by the control unit 11.

The monitor unit 111 may monitor the amount of movement of the communication apparatus 1A at regular intervals, and may monitor the status of a useable RAT or the like, only in a case where the amount of movement is greater than or equal to a prescribed threshold. If a monitoring operation such as scanning RAT information and the like is performed frequently, power consumption of the communication apparatus 1A increases. However, in a case where the amount of movement of the communication apparatus 1A is small, since the probability that the state of the communication apparatus 1A has changed is low, there is little need to frequently execute a monitoring operation. Therefore, it is possible to curtail the power consumption of the communication apparatus 1A by controlling the period and frequency of the monitor operation in accordance with the amount of movement of the communication apparatus 1A.

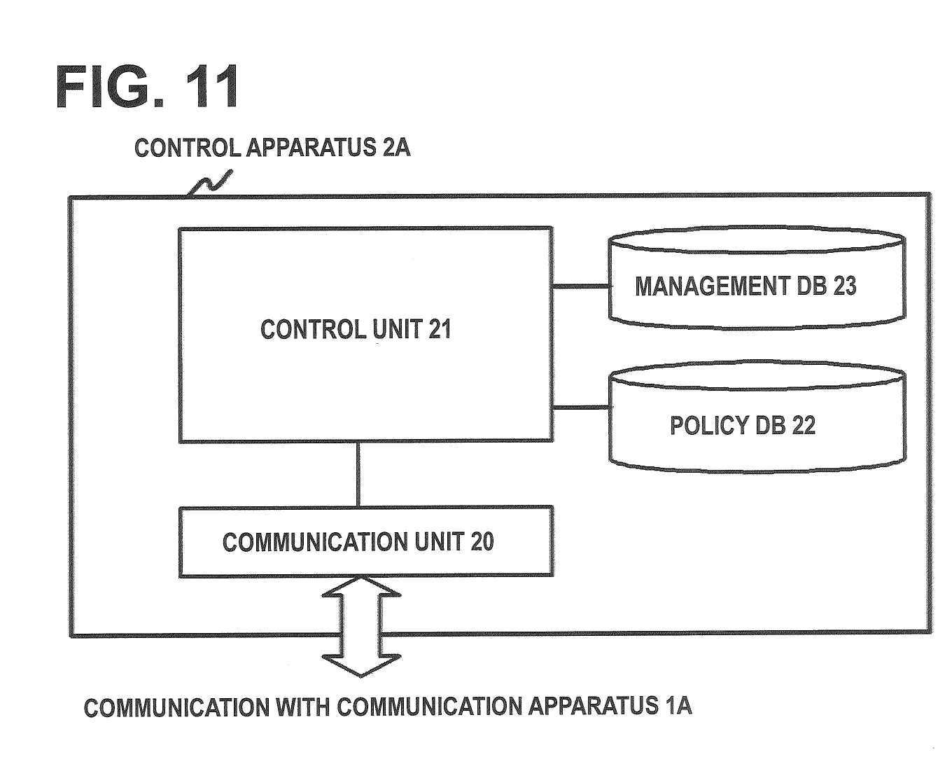

FIG. 11 shows a configuration example of the control apparatus 2A in the present exemplary embodiment. The control apparatus 2A includes a communication unit 20, a control unit 21, a policy DB 22, and a management DB 23. A configuration example of a database stored in the management DB 23 is the same as in FIG. 9.

The communication unit 20 communicates with the communication apparatus 1A. The communication unit 20, for example, receives status information transmitted from the communication apparatus 1A. The communication unit 20 transmits an instruction generated based on a RAT determined based on the received status information, to the communication apparatus 1A.

The control unit 21 makes reference to the policy DB 22 to determine the RAT. That is, the control unit 21 makes reference to the status information received from the communication apparatus 1A, to determine the RAT to which the communication apparatus 1A connects.

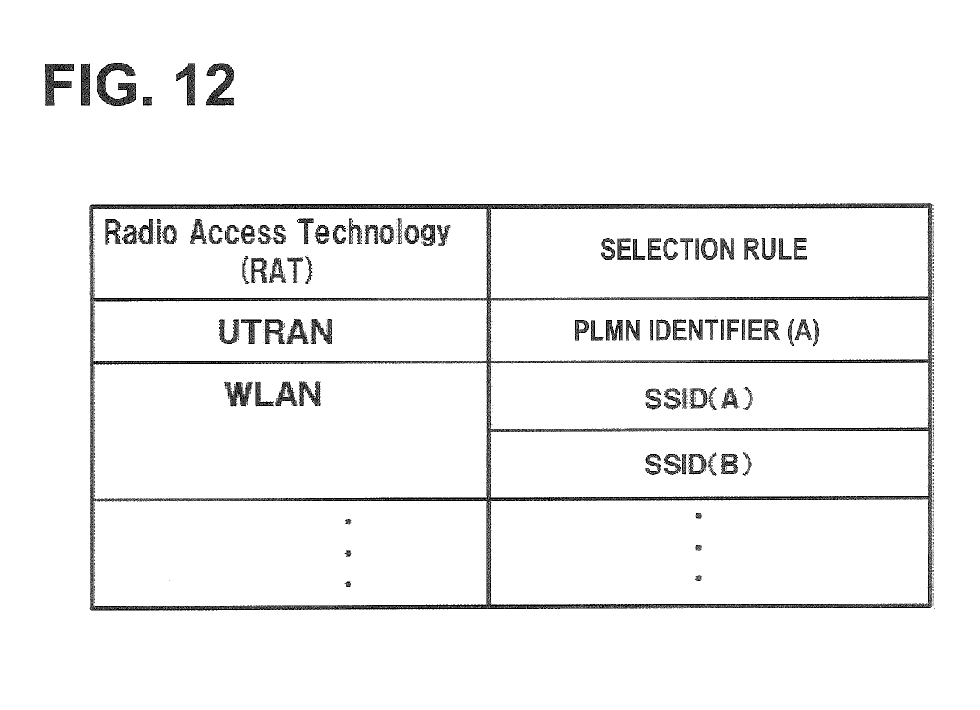

FIG. 12 shows a configuration example of the policy DB 22. It is to be noted that FIG. 12 is an example, and the database held by the policy DB 22 is not limited to FIG. 12.

In FIG. 12, the policy DB 22 holds an identifier of a RAT for selection, for each RAT, as a rule (“selection rule” in the drawings) for determining the RAT. It is to be noted that the policy DB 22, for example, holds data in a structure shown in FIG. 12 for each communication apparatus 1A. The policy DB 22, for example, holds data in the structure shown in FIG. 12 for each identifier (for example, IMSI (International Mobile Subscriber Identity), etc.) of a communication apparatus 1A.

The control unit 21 makes reference to the status information received from the communication apparatus 1A and the policy DB 22, to determine a RAT to which the communication apparatus 1A connects. The status information includes, for example, an identifier of a RAT detected by the communication apparatus 1A. The identifier of the RAT, for example, is a PLMN (Public Land Mobile Network) identifier, which is identifier information of a UTRAN or the like.

The control unit 21, for example, searches for data corresponding to the identifier of the communication apparatus 1A that transmits status information, from the policy DB 22. The control unit 21 compares the identifier of the RAT included in the received status information and the identifier specified in a selection rule of the policy DB 22. In a case where an identifier included in the status information matches an identifier specified as a selection rule, the control unit 21 determines a RAT corresponding to the matching identifier as the RAT to which the communication apparatus 1A connects. In the example of FIG. 12, in a case where the status information includes an SSID (A) that is an identifier of RAT 4-3 of FIG. 1, the control unit 21 instructs the communication apparatus 1A to disguise communication using a communication address corresponding to the RAT 4-3.

In a case where the status information includes information related to a radio wave condition such as field intensity or the like, the control unit 21 refers to the information to determine a RAT. In a case where an identifier included in the status information matches an identifier specified in a selection rule, for example, the control unit 21 selects an identifier with a good radio wave condition, among matching identifiers.

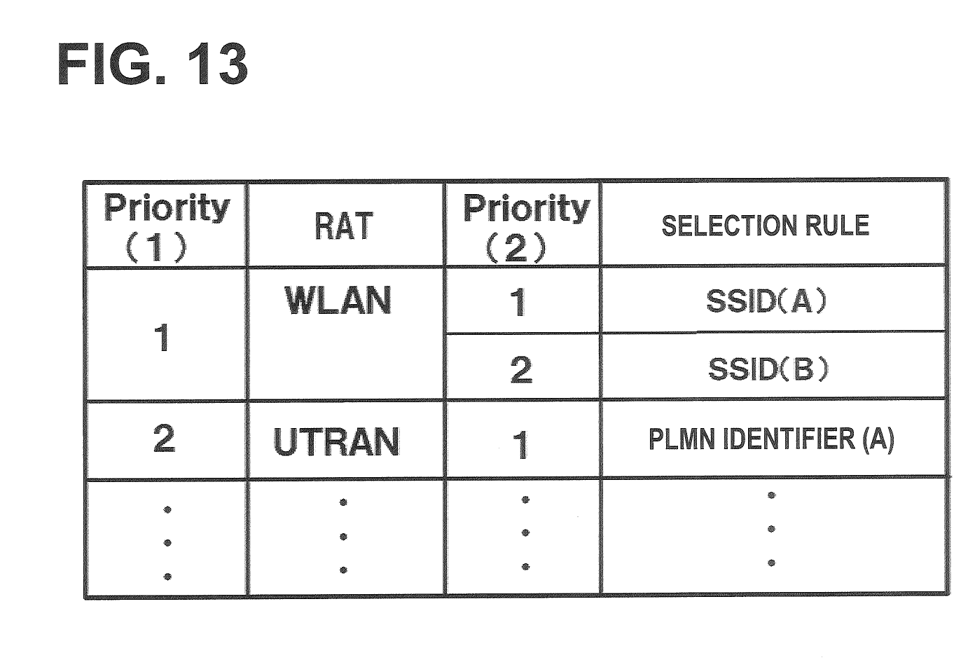

The policy DB 22 may have priorities. FIG. 13 shows an example where the policy DB 22 has priorities. It is to be noted that FIG. 13 is an example, and the database held by the policy DB 22 is not limited to FIG. 13. The policy DB 22, for example, has priorities with respect to RAT (access scheme), and priorities for each selection rule of each RAT (that is, for each identifier of each RAT). The policy DB 22 holds a database of the structure of FIG. 13 for each communication apparatus 1A.

In a case where the status information received from the communication apparatus 1A includes information related to a plurality of RATs, the control unit 21, for example, refers to priorities for each RAT to select a RAT of high priority.

In a case where the status information includes a plurality of identifiers for a certain RAT, the control unit 21, for example, refers to priorities for selection rules, and selects an access network corresponding to an identifier of high priority.

In the example of FIG. 13, in a case where the status information includes an identifier of an UTRAN and an identifier of a WLAN, the control unit 21 controls the communication apparatus 1A so as to connect with a WLAN that has high priority. In a case where the status information includes an SSID (B) that is an identifier of RAT 4-2 and an SSID (A) that is an identifier of RAT 4-3, the control unit instructs the communication apparatus 1A to disguise communication with a communication address corresponding to the WLAN 4-3 that has high priority.

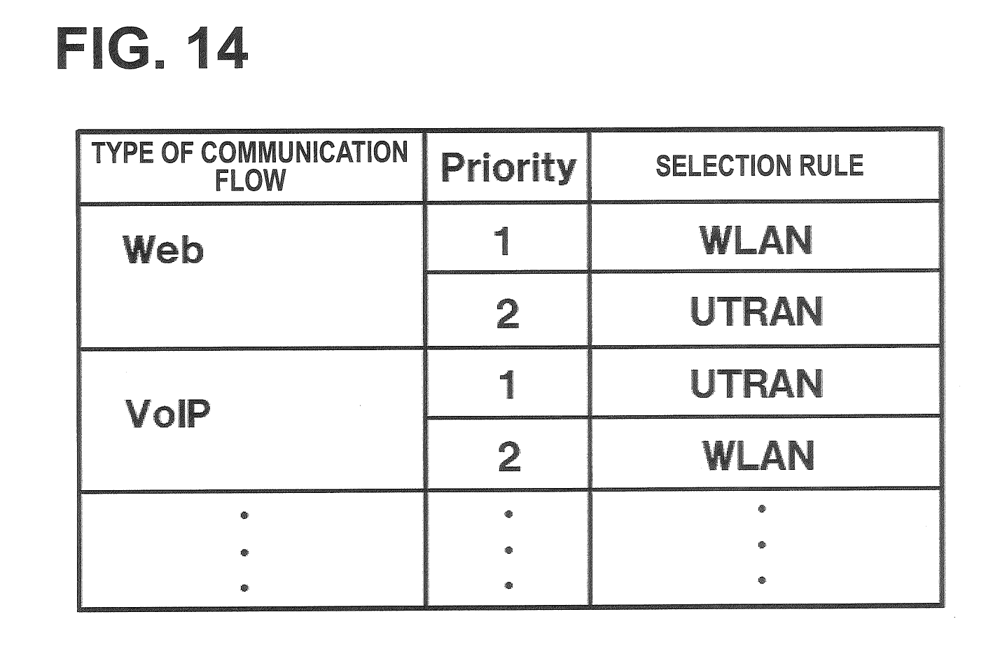

The control unit 21 may select a RAT according to type of communication flow. FIG. 14 shows an example of a policy DB 22 in a case where the control unit 21 selects a RAT according to type of communication flow. It is to be noted that FIG. 14 is an example, and the database held by the policy DB 22 is not limited to FIG. 14.

A communication flow, for example, indicates a communication matching a prescribed condition. For example, a sequence of packets transmitted from a certain transmission source A to a certain destination B belongs to the same communication flow.

With regard to the policy DB 22, a RAT that is a candidate for selection is specified for each type of communication flow. It is to be noted that the policy DB 22 may specify a plurality of RATs that are selection candidates for respective types of communication flow, and may hold priorities for respective RATs.

In the example of FIG. 14, in a case of confirming from status information that a communication apparatus 1A can connect with both a UTRAN and a WLAN, the control unit 21 controls the communication apparatus 1A so as to communicate using the WLAN for Web communication, and to communicate using the UTRAN for VoIP (Voice over IP) communication. The policy DB 22, for example, holds a database of the structure of FIG. 14 for each communication apparatus 1A.

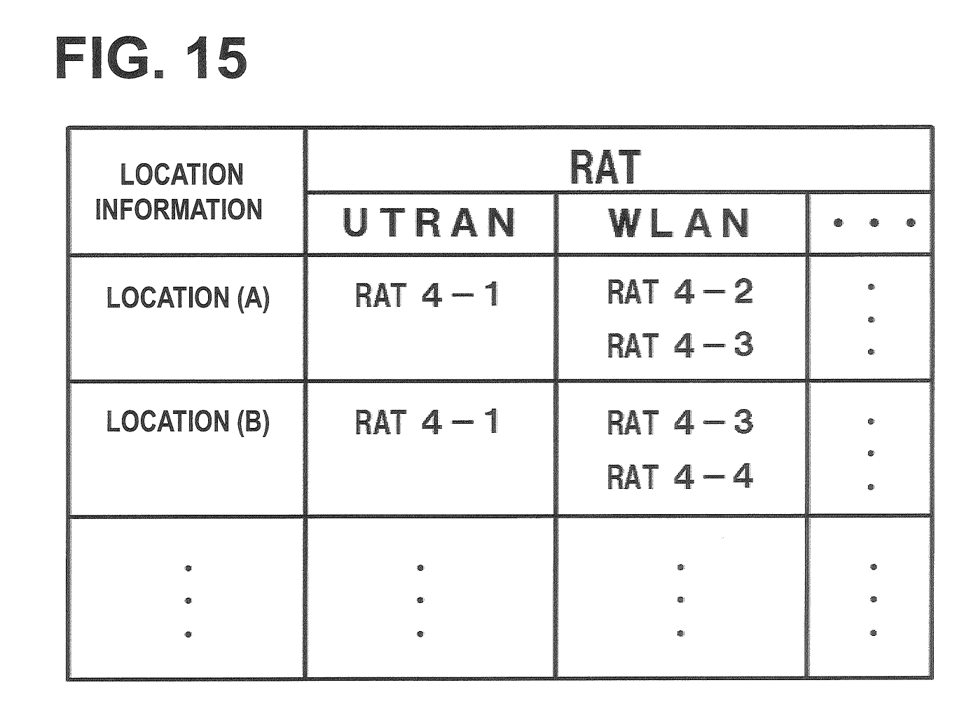

The control unit 21 may select a RAT based on location information of the communication apparatus 1A. FIG. 15 shows an example of the policy DB 22 in a case where the control unit 21 selects a RAT based on location information. It is to be noted that FIG. 15 is an example, and the database held by the policy DB 22 is not limited to FIG. 15.

The location information of FIG. 15, for example, is GPS information or a cell ID. In a case where the location information is GPS information, the location of the communication apparatus 1A is, for example, latitude, longitude, altitude. In a case where the location is a cell ID, the location of the communication apparatus 1A, for example, is estimated from the cell ID and the radio wave reception intensity measured by the communication apparatus 1A for the cell ID in question. The control unit 21, for example, estimates how far the communication apparatus 1A is distant from the central part of the cell, by the radio wave reception intensity, to estimate the location of the communication apparatus 1A. In the case of a cell ID, the location may be estimated using a plurality of cell IDs (a set of a plurality of cell IDs and radio wave reception intensity is also possible), rather than a single cell ID (a set of a single cell ID and radio wave reception intensity is also possible). The policy DB 22, for example, holds a database of a structure of FIG. 15 for each communication apparatus 1A.

In the example of FIG. 15, the policy DB 22 has a database associating a RAT that is a candidate for connection by a communication apparatus 1A, for each item of location information. For example, the policy DB 22 manages a RAT that is useable by the communication apparatus 1A, for each item of location information.

For example, a WiFi access point is arranged at a prescribed location for each network operator. Therefore, by obtaining information related to the access point arrangement from the network operator in advance, the control apparatus 2A can recognize a correspondence relationship between the location information and a RAT corresponding to the access point. The communication apparatus 1A can use an access point of a network operator to which it is subscribed. Accordingly, by referring to information of the subscription between the communication apparatus 1A and the network operator, and the arrangement of the access point of the network operator, the control apparatus 2A can recognize a correspondence relationship between the location information and the useable RAT, and can build the policy DB 22 shown in FIG. 15. The control apparatus 2A may obtain information related to the network operator to which the communication apparatus 1A is subscribed, from the communication apparatus 1A, or may obtain the information from the network operator.

The control unit 21 makes reference to the policy DB 22, to identify a RAT corresponding to location information received from the communication apparatus 1A. The control unit 21 determines a RAT to which the communication apparatus 1A connects, from the RAT identified based on the location information. The control unit 21, for example, may determine a RAT by a method described with reference to FIG. 13 or FIG. 14 (a method based on priority or communication flow), from the RAT identified based on the location information.

The control unit 21 can determine the RAT to which the communication apparatus 1A connects, by any method described with reference to FIG. 12, FIG. 13, FIG. 14, and FIG. 15. The control unit 21 can determine the RAT by arbitrarily combining methods described with reference to FIG. 12, FIG. 13, FIG. 14, and FIG. 15.

As described above, by the control apparatus 2A determining a RAT to which the communication apparatus 1A connects based on the policy DB 22, it is possible to easily select a RAT according to access environment of the communication apparatus 1A.

By the control apparatus 2A switching the RAT to which the communication apparatus 1A connects in accordance with a communication flow, it is possible to control the network traffic of the communication apparatus 1A by the network operator. By the network operator switching the RAT to which the communication apparatus 1A connects, it is possible to disperse the network traffic of the communication apparatus 1A to a plurality of RATs. In this way, the network operator can disperse communication volume which is continually increasing in recent years.

### Fourth Exemplary Embodiment

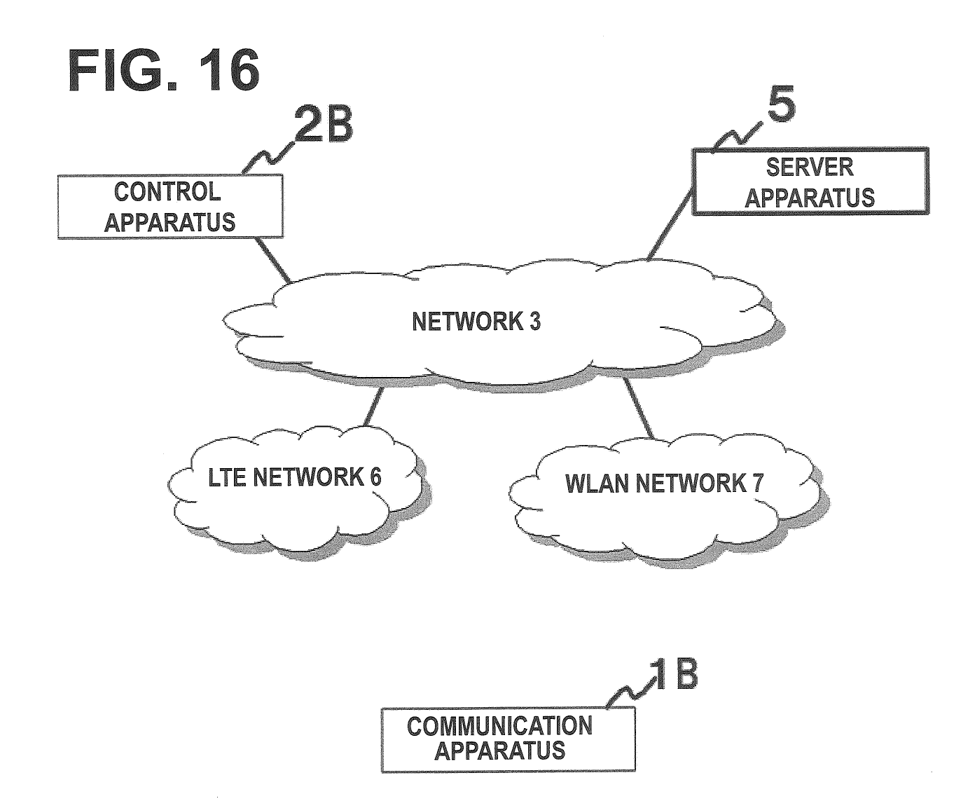

FIG. 16 shows a system configuration example in a fourth exemplary embodiment.

The system of FIG. 16 includes an LTE network 6 and a WLAN network 7, as examples of RATs.

Configurations of a communication apparatus and a control apparatus are different from the exemplary embodiments described above. In the fourth exemplary embodiment, the communication apparatus and the control apparatus are respectively described as the communication apparatus 1B and the control apparatus 2B.

The communication apparatus 1B communicates with a server apparatus 5.

The fourth exemplary embodiment shows an example in which the present invention is implemented by improving technology known as OpenFlow, which is centrally controlled network architecture.

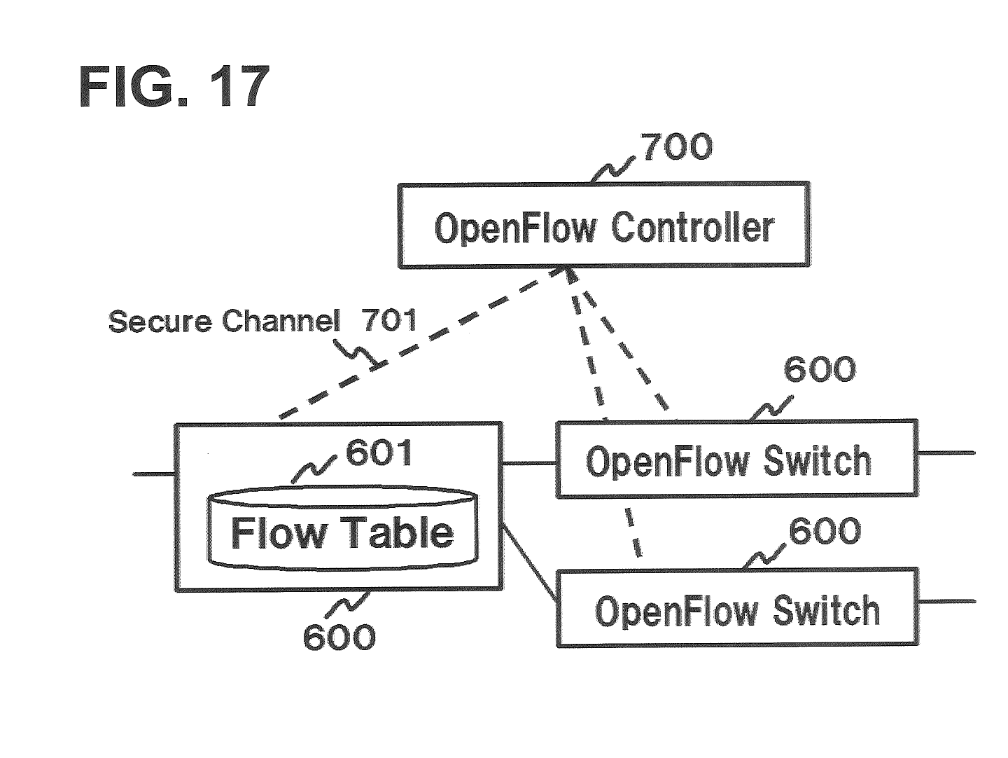

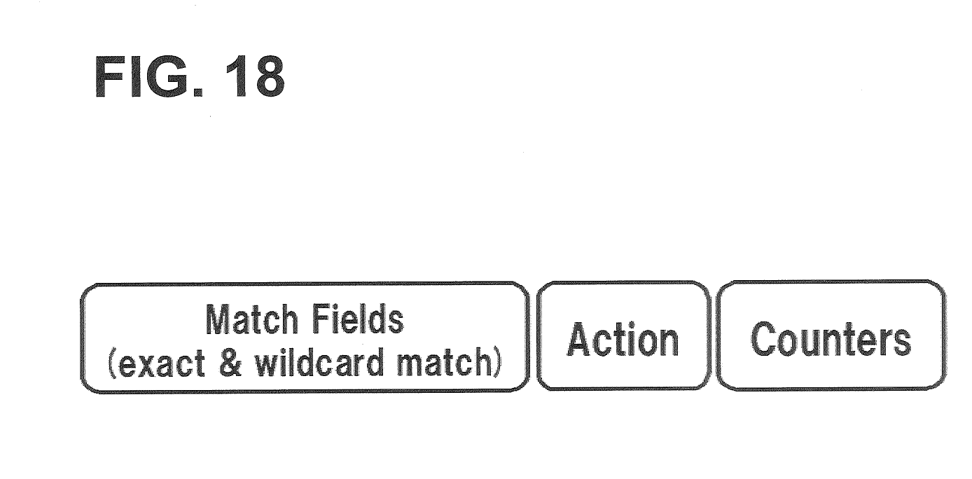

Referring to FIG. 17 and FIG. 18, a description is given concerning OpenFlow technology.

OpenFlow recognizes communication as end-to-end flow, and executes path control, failure recovery, load balancing and the like on a per-flow basis. FIG. 17 shows an outline of a communication system configured according to OpenFlow. It is to be noted that a flow is, for example, a group of a sequence of communication packets having a prescribed attribute. An OpenFlow switch 600 is a network switch that uses OpenFlow technology. An OpenFlow controller 700 is an information processing apparatus that controls the OpenFlow switch 600.

The OpenFlow switch 600 communicates with the OpenFlow controller 700 via a secure channel 701 set between the OpenFlow controller 700 and the OpenFlow switch 600. The OpenFlow controller 700 performs setting of a flow table 601 of the OpenFlow switch 600, via the secure channel 701. It is to be noted that the secure channel 701 is a communication path disposed in order to prevent wiretapping or falsification of communication between the OpenFlow switch 600 and the OpenFlow controller 700.

FIG. 18 shows a configuration example of respective entries (flow entries) of the flow table 601. A flow entry is configured by a matching rule for matching information (for example, destination IP address, VLAN ID, or the like) included in a header of a packet received from a switch, statistical information (Counters) that is statistical information of each packet flow, and actions (Actions) that prescribe a method of processing a packet matching a matching rule.

On receiving a packet, the OpenFlow switch 600 makes reference to the flow table 601. The OpenFlow switch 600 searches for a flow entry that matches header information of a received packet. In a case where an entry that matches header information of the received packet is retrieved, the OpenFlow switch 600 processes the received packet in accordance with a processing method defined in an action field of the retrieved entry. The processing method, for example, defines “forward a received packet from a prescribed port,” “drop a received packet,” or “rewrite part of the header of a received packet and forward from a prescribed port.”

On the other hand, in a case where an entry matching the header information of the received packet is not found, the OpenFlow switch 600, for example, forwards the received packet to the OpenFlow controller 700 via the secure channel 701. By forwarding the received packet, the OpenFlow switch 600 makes a request for setting of a flow entry prescribing a processing method for the received packet, to the Open Flow controller 700. It is to be noted that in a case where the received packet matches an entry prescribing that a request be made for setting of a flow entry to the OpenFlow controller 700, the OpenFlow switch 600 may make a request for setting of the flow entry to the OpenFlow controller 700.

The OpenFlow controller 700 determines a processing method for the received packet, and sets a flow entry including the determined processing method in the flow table 601. Thereafter, the OpenFlow switch 600 processes subsequent packets belonging to the same flow as the received packet by the flow entry that has been set.

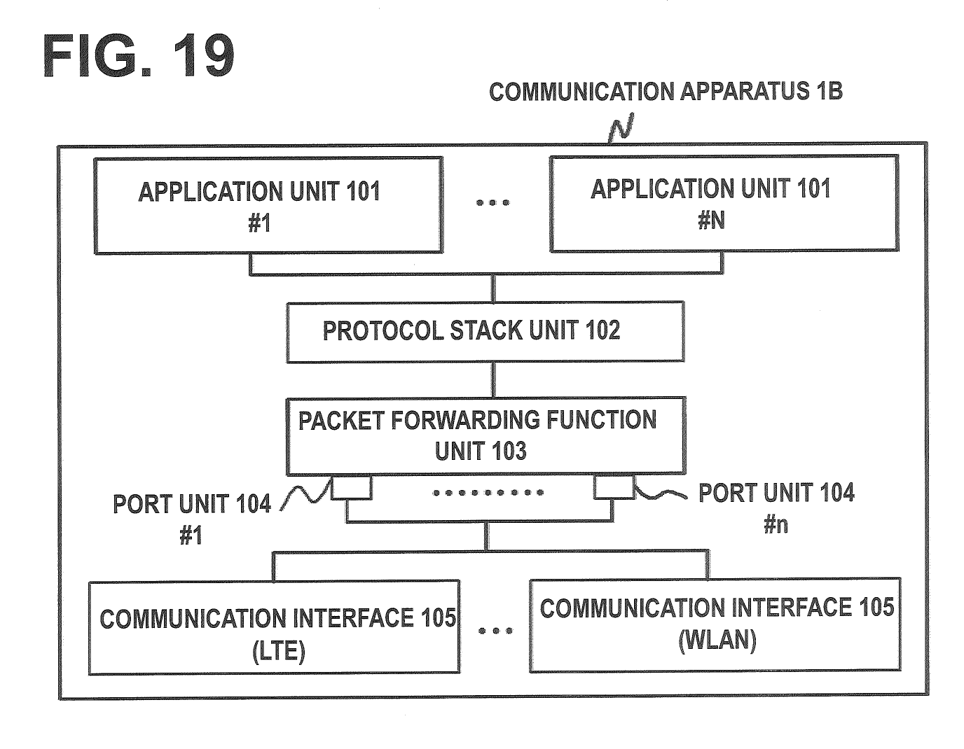

FIG. 19 shows a configuration example of the communication apparatus 1B. The communication apparatus 1B includes a function corresponding to the OpenFlow switch 600. It is to be noted that functionality corresponding to the OpenFlow switch 600 may be either by hardware or software.

A packet forwarding function unit 103 includes a part of the functionality corresponding to the OpenFlow switch 600. The packet forwarding function unit 103 has a plurality of port units 104. In an example of FIG. 19, the packet forwarding function unit 103 has n (n is an integer) port units 104. Respective communication interfaces 105, for example, are associated with at least one of the plurality of port units 104. The packet forwarding function unit 103 transmits/receives data via the port units 104.

In the communication apparatus 1B, a plurality of applications (application unit 101 #1-#N) are running. The applications generate packets, and communicate with the network 3 via a RAT (the LTE network 6 or the WLAN network 7)

When an application transmits a packet to the network 3, the packet is processed by a protocol stack unit 102 (for example, a protocol stack of an OSI (Open Systems Interconnection) reference model or the like), and formed into a packet with a prescribed protocol stack attached. The packet is transmitted from a communication interface 105 via the packet forwarding function unit 103.

The communication apparatus 1B obtains a plurality of respective corresponding IP addresses from the plurality of RATs (for example, the LTE network 6 and the WLAN network 7). The IP address corresponding to the LTE network 6 is IP address (LTE), and the IP address corresponding to the WLAN network 7 is IP address (WLAN).

The application unit 101 and the protocol stack unit 102 generate packets using an arbitrary IP address, among a plurality of IP addresses assigned to the communication apparatus 1B. For example, the application unit 101 and the protocol stack unit 102 generate packets using a first recognized address among the plurality of IP addresses.

The packet forwarding function unit 103 transmits packets from the port unit 104, in accordance with a packet processing rule (for example, a flow entry) set by the control apparatus 2B. Packets forwarded by the port unit 104 are transmitted via any of the communication interfaces 105, to an access network of a RAT corresponding to the interface in question. A packet received from the access network of the RAT by the communication interface 105 is sent to an application via the port unit 103.

The packet forwarding function unit 103 is provided with a function for disguising an IP address used by the application unit 101 and the protocol stack unit 102, by another IP address corresponding to a RAT used by the communication apparatus 1B, in accordance with a packet processing rule set by the control apparatus 2B. The packet forwarding function unit 103 is provided with a function for releasing the disguise of a packet transmitted to the communication apparatus 1B, using an IP address corresponding to the RAT used by the communication apparatus 1B. In a case where the application unit 101 and the protocol stack unit 102 use an IP address corresponding to the RAT used by the communication apparatus 1B, the packet forwarding function unit 103 need not disguise the IP address of the packet.

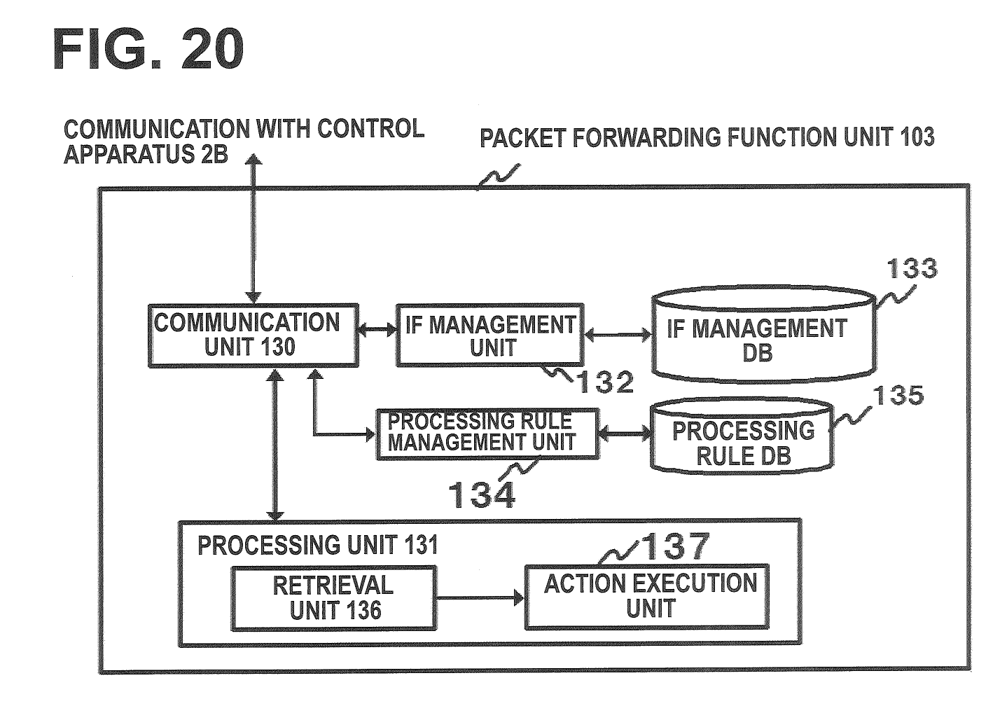

FIG. 20 is a configuration example of the packet forwarding function unit 103.

The communication unit 130 communicates with the control apparatus 2B. The communication unit 130, for example, sets a secure channel 701 between itself and the control apparatus 2B, in order that the packet forwarding function unit 103 receives a packet processing rule transmitted from the control apparatus 2B. The control unit 130, for example, makes a request for a packet processing rule to the control apparatus 2B, via the secure channel 701 that has been set.

The communication unit 130 delivers the packet processing rule received from the control apparatus 2B to the processing rule management unit 134. The processing rule management unit 134 stores the packet processing rule received from the control apparatus 2B in a processing rule DB 135.

A processing unit 131 executes processing such as packet forwarding or rewriting of a packet header portion, in accordance with a packet processing rule set by the control apparatus 2B. A retrieval unit 136 retrieves a packet processing rule matching a packet, among packet processing rules stored in the processing rule DB 135. The retrieval unit 136, for example, collates packet content and a matching rule of the packet processing rule, and retrieves a processing rule including the matching rule that matches the packet content. In a case where a processing rule matching the packet is not stored in the processing rule DB 135, the retrieval unit 136, for example, notifies the communication unit 130 and the communication unit 130 makes a request for a packet processing rule to the control apparatus 2B. It is to be noted that a configuration of the packet processing rule may be the same as the configuration shown in FIG. 18.

An action execution unit 137 processes the packet in accordance with a processing rule specified in the packet processing rule retrieved by the retrieval unit 136. For example, the action execution unit 137 executes processing in which the packet is forwarded from a prescribed port unit 104, processing in which the packet content is rewritten, or the like.

The action execution unit 137 disguises an IP address in accordance with a packet processing rule. That is, the action execution unit 137 disguises the IP address of a communication flow corresponding to a packet processing rule retrieved by the retrieval unit 136.

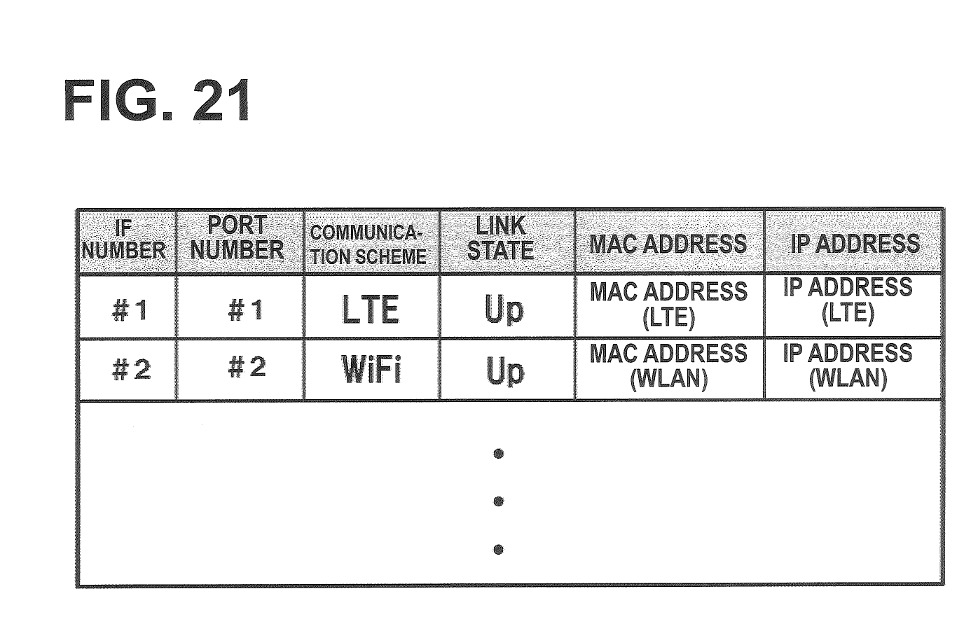

An IF (Interface) management unit 132 manages information related to a communication interface 105, using an IP management DB 133. The IF management DB 133, for example, has a database as exemplified in FIG. 21. The database, for example, holds the number of the corresponding port unit 104, a corresponding communication scheme, the state of a link between the communication interface 105 and a RAT, and addresses corresponding to the communication interface 105 (for example, a MAC (Media Access Control) address and an IP address), for each communication interface 105.

In a case where a correspondence relationship between the communication interface 105 and the port unit 104 is changed, the IF management unit 132 updates the IF management DB 133.

The IF management unit 132 gives notification of at least some of the information managed by the IF management DB 133 to the control apparatus 2B, via the communication unit 130. The control apparatus 2B recognizes the state of the communication apparatus 1B, by receiving this information. In a case of receiving a request from the control apparatus 2B, for example, the IF management unit 132 gives notification of this information.

In a case where the communication interface used is switched in accordance with an instruction from the control apparatus 2B, the IF management unit 132 changes the port unit used by the packet forwarding function unit 103. In a case where the port unit used by the packet forwarding function unit 103 is changed accompanying switching of the communication interface, the IF management unit 132 updates the IF management DB 133. It is to be noted that the IF management DB 133 may manage a correspondence relationship between a contact point (for example, an access point) of a RAT to which the communication interface is connected, and the port unit.

The OpenFlow technology described above has a function (Port Status) by which the state of a port of a switch is notified to a controller, and a function (Feature Request/Reply) by which a feature of a switch is notified to the controller. The IF management unit 132 may use these functions when giving notification of information to the control apparatus 2B.

The communication apparatus 1B may be provided with a function for downloading a software module having a function equivalent to the packet forwarding function unit 103. The communication apparatus 1B may use the downloaded software module as the packet forwarding function unit 103.

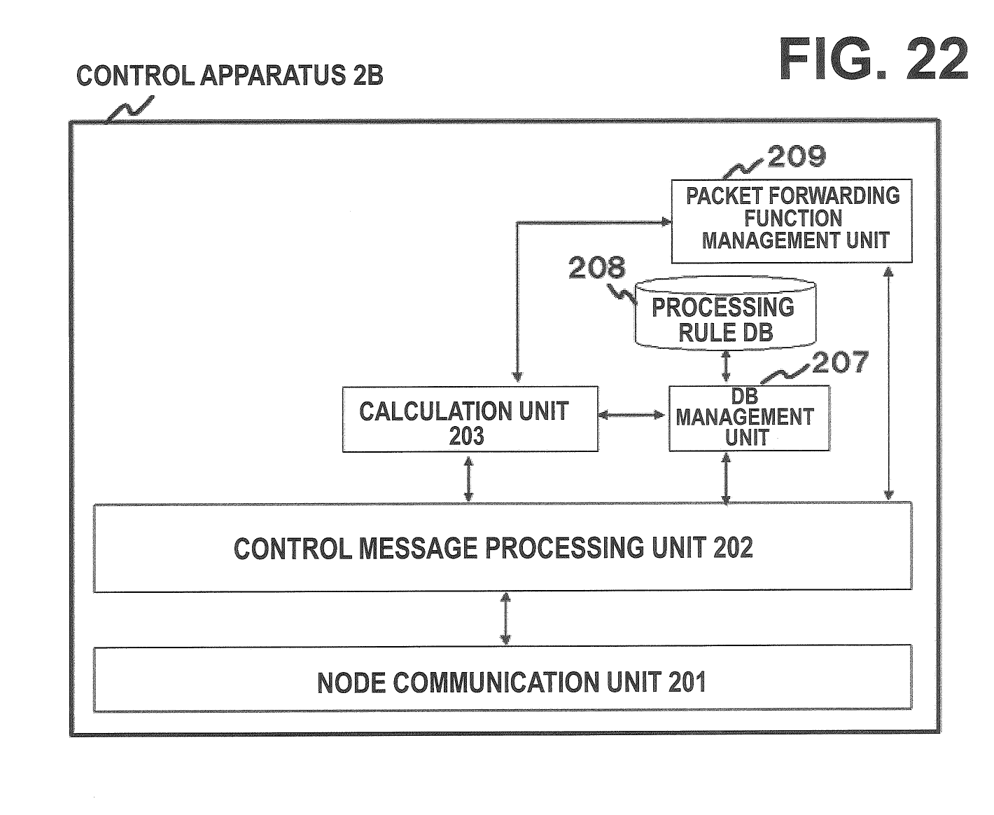

FIG. 22 shows a configuration example of the control apparatus 2B.

The processing rule DB 208 stores a packet processing rule for setting in the communication apparatus 1B. It is to be noted that a configuration of the packet processing rule may be the same as the configuration shown in FIG. 18.

A node communication unit 201 communicates with the communication apparatus 1B. The node communication unit 201 forwards information received from the communication apparatus 1B to a packet forwarding function management unit 209.

The packet forwarding function management unit 209 manages information (for example, the information exemplified in FIG. 21) transmitted from the IF management unit 132 of the communication apparatus 1B. The control apparatus 2B recognizes the state of the communication apparatus 1B, by the packet forwarding function management unit 209.

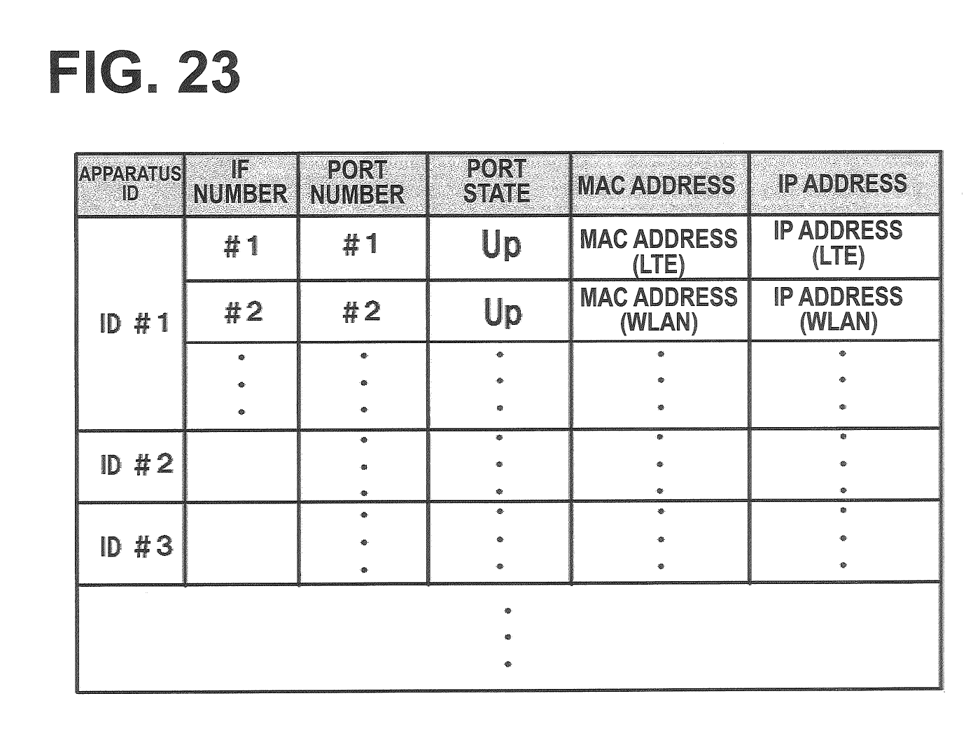

The packet forwarding function management unit 209 manages information notified by communication apparatus for each communication apparatus 1B. The packet forwarding function management unit 209, for example, manages information by a database as exemplified in FIG. 23.

A calculation unit 203 determines packet processing to be executed in a packet forwarding path and a switch in the forwarding path, based on network topology. That is, the calculation unit 203 calculates a packet forwarding path, and determines a packet processing rule corresponding to the forwarding path.

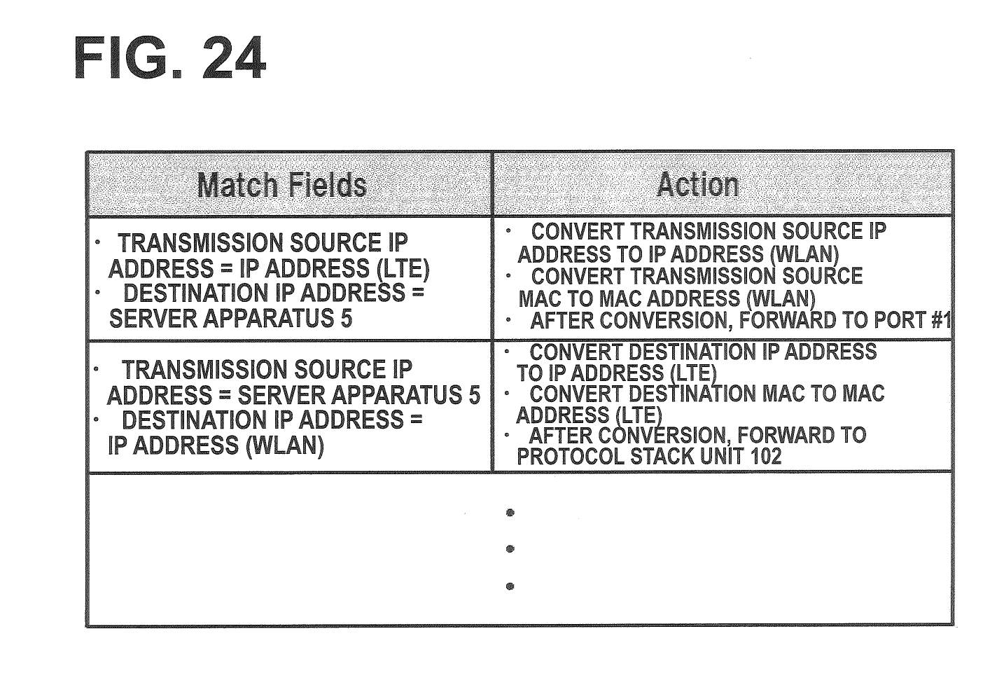

The calculation unit 203 refers to information managed by the packet forwarding function management unit 209 and determines a processing rule for disguising an IP address. The calculation unit 203, for example, transmits a packet processing rule as exemplified in FIG. 24, to the communication apparatus 1B. The control apparatus 2B, for example, determines a RAT to be used by the communication apparatus 1B, by a method as in the third exemplary embodiment. The calculation unit 203 determines a packet processing rule prescribing disguising of communication using an address corresponding to a RAT used by the communication apparatus 1B. In a case where a RAT used by the communication apparatus 1B is determined to be a WLAN, the calculation unit 203, as in an example of FIG. 24, determines a packet processing rule that converts a transmission source IP address to an IP address corresponding to the WLAN network, for a communication flow where the transmission source IP address is an IP address corresponding to an LTE network. The calculation unit 203, as in the example of FIG. 24, determines a packet processing rule that converts a destination IP address to an IP address corresponding to the LTE network, for a communication flow where the IP address corresponding to a WLAN network is the destination. The calculation unit 203 instructs the communication apparatus 1B to disguise communication, by the packet processing rule described above.

The DB management unit 207 records the packet processing rule determined by the calculation unit 203 in the processing rule DB 208. The DB management unit 207 transmits a packet processing rule to the communication apparatus 1B, in response to a request for a packet processing rule being transmitted from the communication apparatus 1B.

A control message processing unit 202 analyzes a control message (for example, a request to set a packet processing rule, or the like) received from the communication apparatus 1B, and performs processing corresponding to the control message. The control message processing unit 202 generates a message (for example, a message for setting a packet processing rule, or the like) to be transmitted to the communication apparatus 1B.

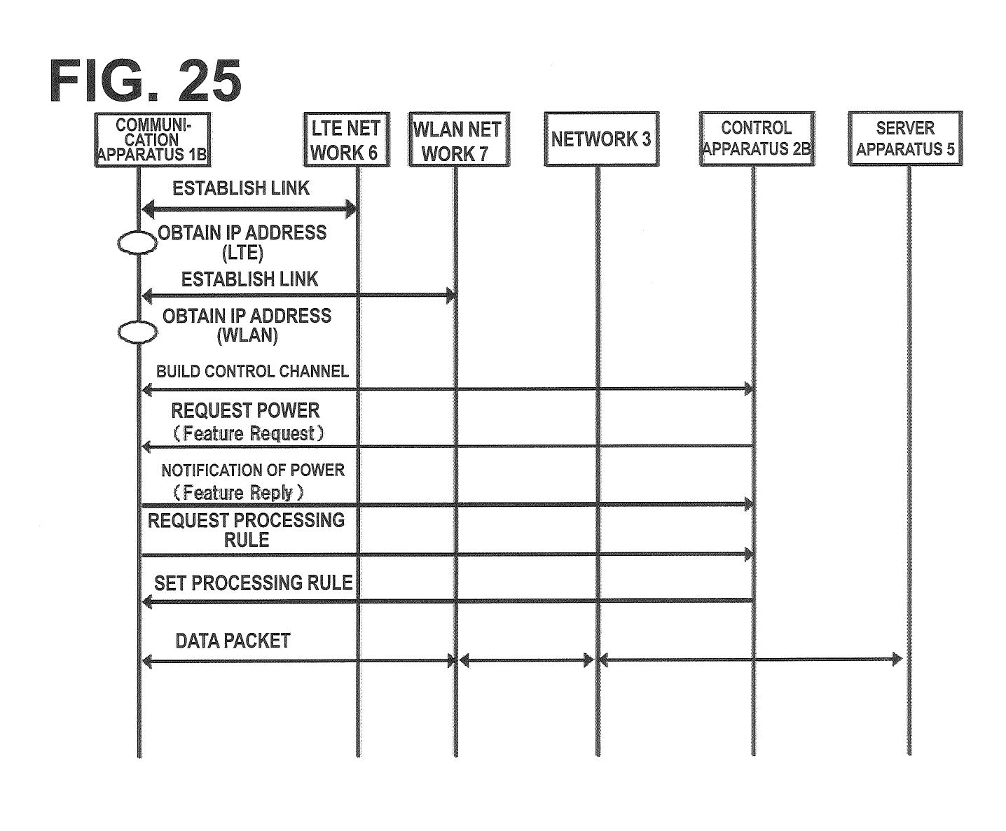

FIG. 25 is a sequence diagram showing an operation example of the fourth exemplary embodiment.

The communication apparatus 1B establishes links with each of the LTE network 6 and the WLAN network 7. The communication apparatus 1B obtains IP addresses from each of the LTE network 6 and the WLAN network 7.

The packet forwarding function unit 103 sets a control channel between itself and the control apparatus 2B, via any RAT in which a link is established. The packet forwarding function unit 103 communicates with the control apparatus 2B, via the control channel. The control channel, for example, is the secure channel 701 of the OpenFlow technology described above.

The control apparatus 2B makes a request to the communication apparatus 1B for transmission of information related to a feature of the communication apparatus 1B, via the control channel (Feature Request).

The packet forwarding function unit 103 gives notification of information to the control apparatus 2B, in response to the request from the control apparatus 2B. The packet forwarding function unit 103 may notify the control apparatus 2B of information exemplified in FIG. 21, by using a “Feature Reply” function.

In a case of receiving a packet for which a corresponding processing rule is unknown, or a case of receiving a packet corresponding to a processing rule prescribing an enquiry to the control apparatus, the packet forwarding function unit 203 makes a request for a packet processing rule to the control apparatus 2B, at a prescribed timing.

The control apparatus 2B determines a packet processing rule in response to the request from the packet forwarding function unit 203 and transmits the packet processing rule to the communication apparatus 1B. The control apparatus 2B determines a RAT to be used by the communication apparatus 1B. The control apparatus 2B makes reference to information (an IP address assigned to the communication apparatus 1B) notified by the packet forwarding function unit 203, and notifies the packet forwarding function unit 203 of an instruction to disguise an address corresponding to a RAT to be used by the communication apparatus 1B.

The communication apparatus 1B communicates with a server apparatus 5 that is a communication partner, based on the instruction transmitted from the control apparatus 2B.

### Fifth Exemplary Embodiment

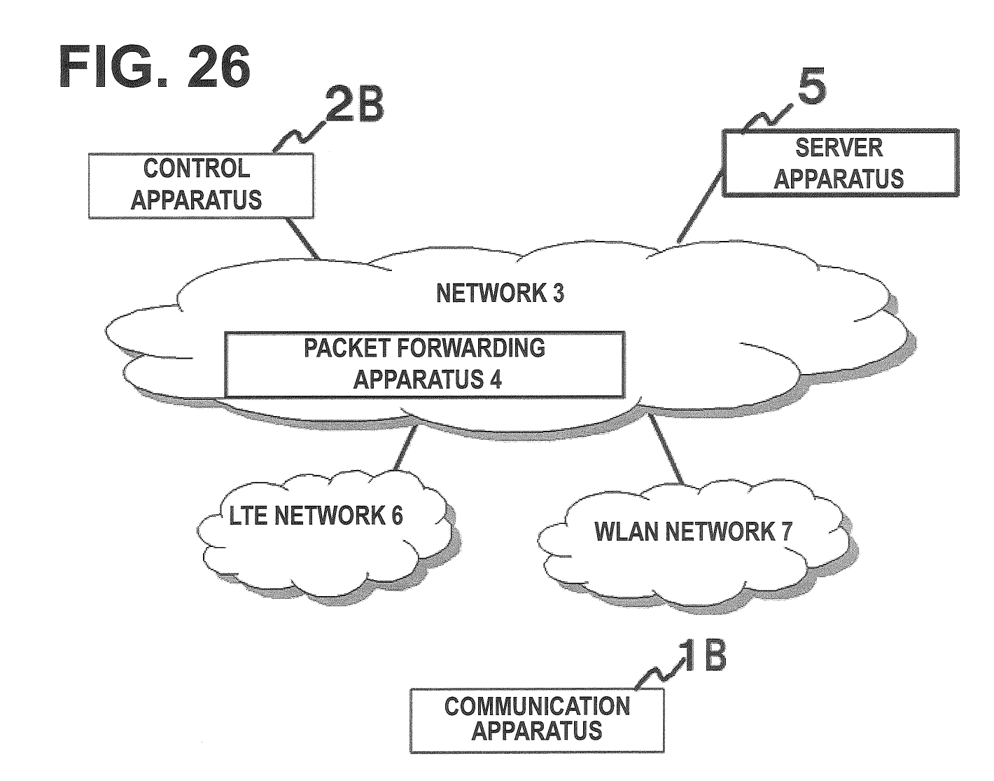

FIG. 26 shows an example of a system configuration example in a fifth exemplary embodiment.

In the fifth exemplary embodiment, a network 3 includes a packet forwarding apparatus 4. The fifth exemplary embodiment is otherwise the same as the fourth exemplary embodiment.

The packet forwarding apparatus 4 releases a disguise of a packet transmitted from a communication apparatus 1B. By the packet forwarding apparatus 4 releasing the disguise, a communication address used by an application of the communication apparatus 1B and a communication address recognized as an identifier of the communication apparatus 1B by a communication partner are the same. Therefore, in the fifth exemplary embodiment, even where the communication apparatus 1B performs handover between different RATs, it is not necessary to change a communication address of the communication apparatus 1B, and it is possible to avoid a communication interruption (session disconnection) due to the handover.

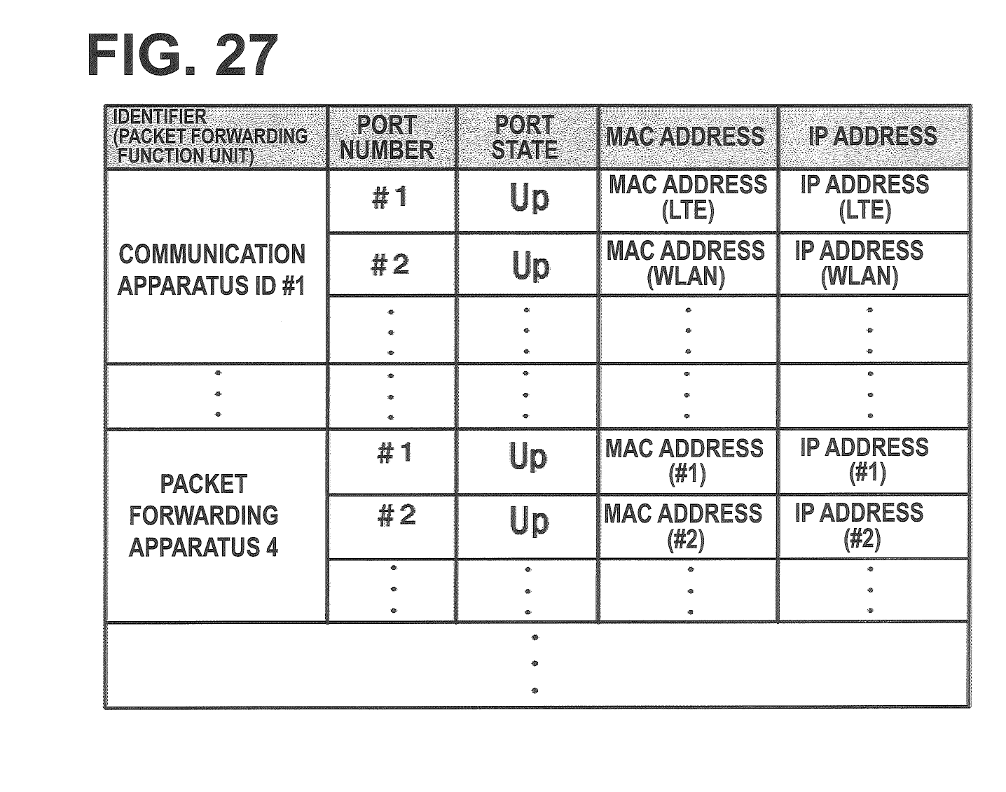

The packet forwarding function management unit 209 of the control apparatus 2B manages information shown in FIG. 27. Note that FIG. 27 is an example, and the information managed by the packet forwarding function management unit 209 is not limited to FIG. 27.

The control apparatus 2B generates an instruction to be transmitted to a packet forwarding function unit 103 and the packet forwarding apparatus 4 of the communication apparatus 1B, based on information managed by the packet forwarding function management unit 209.

The packet forwarding function management unit 209 manages the state of each port and a communication address (for example, a MAC address or an IP address) corresponding to each port, for each port number of the packet forwarding apparatus 4 and the communication apparatus 1B.

A calculation unit 203 of the control apparatus 2B transmits an instruction to disguise communication, to the communication apparatus 1B, based on information managed by the packet forwarding function management unit 209. The calculation unit 203 transmits an instruction to release the disguise by the communication apparatus 1B, based on information managed by the packet forwarding function management unit 209, to the packet forwarding apparatus 4.

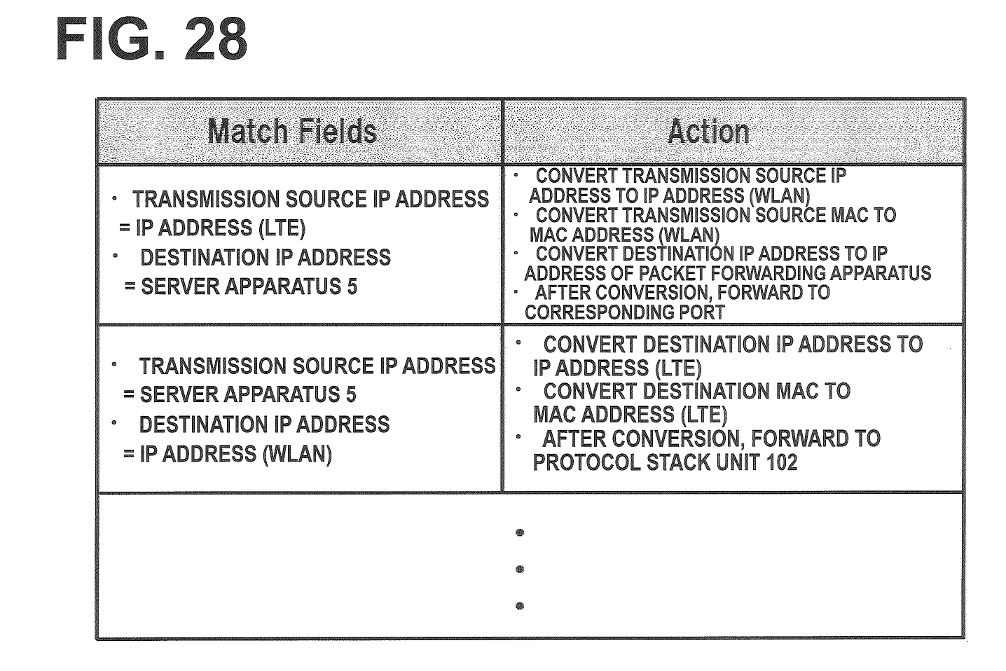

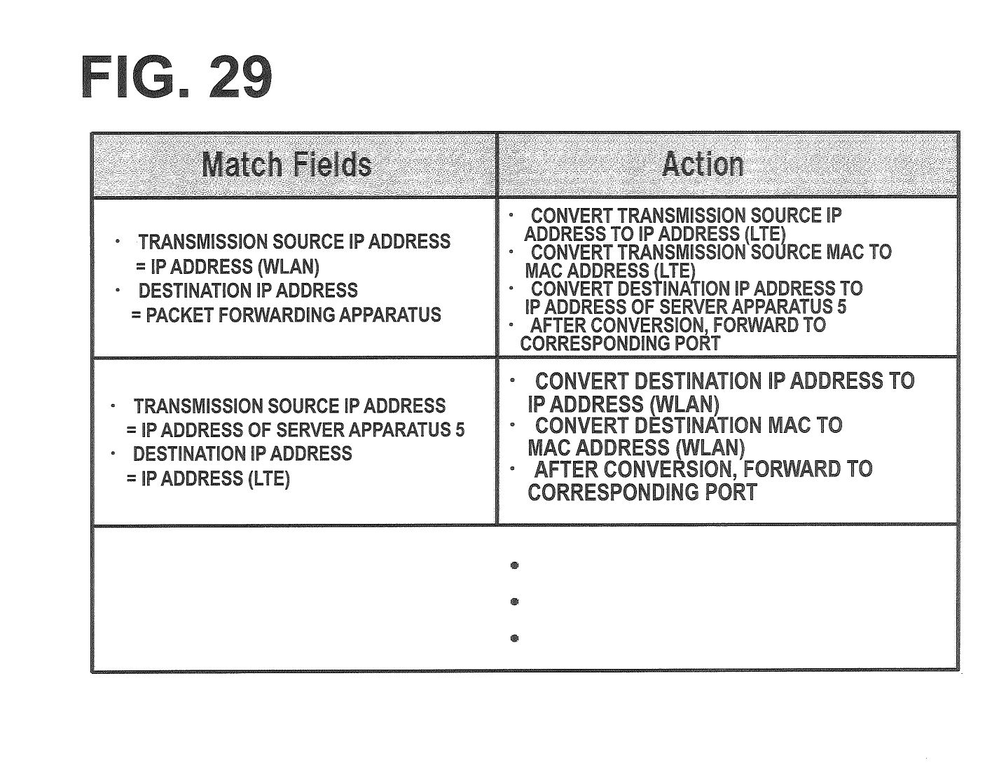

Making reference to FIG. 28 and FIG. 29, a description is given of an example of operation of the communication apparatus 1B and the packet forwarding apparatus 4, according to an instruction of the control apparatus 2B. FIG. 28 shows an example of an instruction notified to the communication apparatus 1B from the control apparatus 2B. FIG. 29 shows an example of an instruction notified to the packet forwarding apparatus 4 from the control apparatus 2B.

The packet forwarding function unit 103 of the communication apparatus 1B disguises a communication address used as an identifier of the communication apparatus 1B, by a communication address instructed by the control apparatus 2B. In an example of FIG. 28 (first line of the table of FIG. 28), in a case of using an address (IP address (LTE)) corresponding to an LTE network 6 as a communication address of an identifier of the communication apparatus 1B, the packet forwarding function unit 103 converts the address to an address (IP address (WLAN)) corresponding to a WLAN network 7. It is to be noted that the packet forwarding function unit 103 may convert a MAC address of a packet transmission source to a MAC address (MAC address (WLAN)) corresponding to the WLAN network 7.

The packet forwarding function unit 103 converts the destination of a packet whose transmission source address is disguised, to an address of the packet forwarding apparatus 4. The packet forwarding function unit 103, for the packet whose destination address was converted, forwards a packet from a port unit 104 corresponding to a forwarding path to the packet forwarding apparatus 4.

The packet forwarding apparatus 4 that receives a packet from the communication apparatus 1B releases an address disguise. In an example of FIG. 29 (first line of the table of FIG. 29), in a case where the packet forwarding apparatus 4 receives a packet with a destination of the packet forwarding apparatus 4, with a transmission source address being an address (IP address (WLAN)) for a WLAN of the communication apparatus 1B, the packet forwarding apparatus 4 converts the packet transmission source address to an address (IP address (LTE)) for LTE of the communication apparatus 1B. It is to be noted that the packet forwarding apparatus 4 may convert a MAC address of the packet transmission source to a MAC address (MAC address (LTE)) for LTE of the communication apparatus 1B.

The packet forwarding apparatus 4 converts the packet destination address to an address of a server apparatus 5. The packet forwarding apparatus 4 forwards the packet whose destination address was converted, from a port corresponding to a forwarding path to the server apparatus 5.

The server apparatus 5 that receives the packet via the packet forwarding apparatus 4, which was transmitted from the communication apparatus 1B, transmits a reply packet with a destination of the communication apparatus 1B. By the packet forwarding apparatus 4 releasing the packet disguise, the server apparatus 5 recognizes that the address of the communication apparatus 1B is an address (IP address (LTE)) for LTE, from the transmission source address of the received packet. Therefore, the server apparatus 5 sets the destination of the reply packet to an LTE address (IP address (LTE)) of the communication apparatus 1B.

It is to be noted that in the present exemplary embodiment, with regard to the network 3, a packet with a destination of the communication apparatus 1B is set so as to pass via the packet forwarding apparatus 4. Therefore, the reply packet transmitted by the server apparatus 5 goes via the packet forwarding apparatus 4.

The packet forwarding apparatus 4 receives the packet with a destination of the communication apparatus 1B, that was transmitted by the server apparatus 5. The destination of the packet is an LTE address of the communication apparatus 1B, and the transmission source is the server apparatus 5. Therefore, the packet forwarding apparatus 4 converts the destination address of the packet to a WLAN address of the communication apparatus 1B, in accordance with the example of FIG. 29 (second line of the table of FIG. 29). The packet forwarding apparatus 4 forwards the packet whose destination address was converted, from a port corresponding to a forwarding path to the communication apparatus 1B.

In a case of receiving a packet with a transmission source of the server apparatus 5, and a destination of a WLAN address of the communication apparatus 1B, the packet forwarding function unit 103 of the communication apparatus 1B converts the packet address in accordance with the example of FIG. 28 (second line of the table of FIG. 28). The packet forwarding function unit 103 converts the destination of the received packet to an LTE address of the communication apparatus 1B, and transmits the packet to a protocol stack unit 102.

By the above operations, communication between the communication apparatus 1B and the server apparatus 5 is executed via the packet forwarding apparatus 4.

The entire disclosures of the above Patent Literatures are incorporated herein by reference thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

Note that the term “means” used herein is interchangeable with the term “unit,” and vice versa. Note further that the singular form disclosed herein may also represent the plural form, as is relevant in the art, and particularly based on the priority text which is in Japanese language having inherently no difference between the singular form and the plural form.

### REFERENCE SIGNS LIST

1 communication apparatus
1B communication apparatus
2 control apparatus
2B control apparatus
3 network
4 RAT
5 server apparatus
6 LTE network
7 WLAN network
10 communication interface
11 control unit
20 communication unit
21 control unit
22 policy DB
23 management DB
101 application unit
102 protocol stack unit
103 packet forwarding function unit
104 port unit
105 communication interface
111 monitor unit
112 notification unit
130 communication unit
131 processing unit
132 IF management unit
133 IF management DB
134 processing rule management unit
135 processing rule DB
136 retrieval unit
137 action execution unit
201 node communication unit
202 control message processing unit
203 calculation unit
207 DB management unit
208 processing rule DB
209 packet forwarding function management unit
600 OpenFlow switch
601 flow table
700 OpenFlow controller
701 secure chanel

What is claimed is:

1. A communication apparatus, comprising:
a communication unit that communicates with a network by at least one of a plurality of communication schemes; and
a control unit that disguises a first communication address corresponding to a first communication scheme, by a second communication address corresponding to a second communication scheme, based on an instruction transmitted from a control apparatus.

2. The communication apparatus according to claim 1, wherein
the control unit disguises the first communication address by the second communication address, for a communication corresponding to a condition included in an instruction transmitted from the control apparatus.

3. The communication apparatus according claim 1, wherein
the control unit disguises the first communication address by the second communication address corresponding to a communication scheme used in communication.

4. The communication apparatus according to claim 1, wherein
the control unit disguises the first communication address that is used by a program running on the communication apparatus, by the second communication address.

5. The communication apparatus according to claim 1, further comprising:
a plurality of communication interfaces that correspond to at least one of the plurality of communication schemes, wherein
the control unit transmits a packet disguised by the second communication address, via a communication interface corresponding to the second communication address.

6. The communication apparatus according to claim 1, wherein
the control apparatus disguises the first communication address by the second communication address, by an instruction determined by the control apparatus based on a status of the communication apparatus that changes with movement of the communication apparatus.

7. The communication apparatus according to claim 1, wherein
the control unit notifies the control apparatus of a communication address assigned to the communication apparatus.

8. The communication apparatus according to claim 1, wherein
the control unit establishes a communication channel between the communication apparatus and the control apparatus, and notifies the control apparatus, via the communication channel, of a communication address assigned to the communication apparatus.

9. The communication apparatus according to claim 1, wherein
the control unit comprises:
a processing unit that processes a packet in accordance with a processing rule transmitted from the control apparatus; and
a request unit that makes a request for a processing rule corresponding to a received packet to the control apparatus, and
the control unit disguises the first communication address by the second communication address, based on an instruction transmitted from the control apparatus in response to the request.

10. The communication apparatus according to claim 9, wherein
the control unit notifies the control apparatus of a communication address assigned to the communication apparatus, in response to a request for information related to the communication apparatus, transmitted from the control apparatus.

11. The communication apparatus according to claim 1, wherein
the control unit disguises the first communication address by the second communication address, by conversion of a communication address.

12. The communication apparatus according to of claim 1, wherein
the control unit disguises the first communication address by the second communication address, by attaching and removing a communication address.

13. A communication method, comprising:
using a communication apparatus that communicates with a network by at least one of a plurality of communication schemes;
disguising a first communication address corresponding to a first communication scheme, by a second communication address corresponding to a second communication scheme, based on an instruction transmitted from a control apparatus; and
communicating using the disguised communication address.

14. The communication method according to claim 13, wherein
the communication apparatus disguises the first communication address by the second communication address, for a communication corresponding to a condition included in an instruction transmitted from the control apparatus.

15. The communication method according to claim 13, wherein
the communication apparatus disguises the first communication address by the second communication address that corresponds to a communication scheme used in communication.

16. The communication method according to claim 13, wherein
the communication apparatus disguises the first communication address used by a program running on the communication apparatus, by the second communication address.

17. The communication method according to claim 13, wherein
the communication apparatus comprises a plurality of communication interfaces that correspond to at least one of the plurality of communication schemes, and
the communication apparatus transmits a packet disguised by the second communication address via a communication interface corresponding to the second communication address.

18. The communication method according to claim 13, wherein
the communication apparatus disguises the first communication address by the second communication address, by an instruction determined by the control apparatus based on a status of the communication apparatus that changes with movement of the communication apparatus.

19. The communication method according to claim 13, wherein
the communication apparatus notifies the control apparatus of a communication address assigned to the communication apparatus.

20. The communication method according to claim 13, wherein
the communication apparatus establishes a communication channel between the communication apparatus and the control apparatus, and notifies the control apparatus, via the communication channel, of a communication address assigned to the communication apparatus.

21. The communication method according to claim 13, further comprising:
by the communication apparatus, processing a packet in accordance with a processing rule transmitted from the control apparatus; and
making a request for a processing rule corresponding to a received packet to the control apparatus, wherein
the communication apparatus disguises the first communication address by the second communication address, based on an instruction transmitted from the control apparatus in response to the request.

22. The communication method according to claim 21, further comprising:
by the communication apparatus, notifying the control apparatus of a communication address assigned to the communication apparatus, in response to a request for information related to the communication apparatus, transmitted from the control apparatus.

23. The communication method according to claim 13, wherein
the communication apparatus disguises the first communication address by the second communication address, by conversion of a communication address.

24. The communication method according to claim 13, wherein
the communication apparatus disguises the first communication address by the second communication address, by attaching and removing a communication address.

25. A communication system, comprising:
a communication apparatus; and
a control apparatus that controls packet processing by the communication apparatus; wherein
the communication apparatus comprises:
a communication unit that communicates with a network by at least one of a plurality of communication schemes; and
a control unit that disguises a first communication address corresponding to a first communication scheme, by a second communication address corresponding to a second communication scheme, based on an instruction transmitted from the control apparatus.

26. A control apparatus, comprising:
a unit that communicates with a communication apparatus that uses at least one of a plurality of communication schemes; and
a unit that transmits to the communication apparatus an instruction to disguise a first communication address corresponding to a first communication scheme, by a second communication address corresponding to a second communication scheme.

27. A communication method, comprising:
communicating with a communication apparatus that uses at least one of a plurality of communication schemes; and
transmitting to the communication apparatus an instruction to disguise a first communication address corresponding to a first communication scheme, by a second communication address corresponding to a second communication scheme.

28. A non-transitory computer-readable recording medium, storing a program that causes a communication apparatus that communicates with a network by at least one of a plurality of communication schemes to execute:
disguising a first communication address corresponding to a first communication scheme, by a second communication address corresponding to a second communication scheme, based on an instruction transmitted from a control apparatus.
